(19) United States
(12) Patent Application Publication
(10) Pub. No.: US 2006/0074705 A1
(43) Pub. Date: Apr. 6, 2006

(54) Method and system for residential property data capture, process, and distribute on-line for sale or lease purpose

(75) Inventors: David B. Carolan, Austin, TX (US); Maria Isbell, Austin, TX (US)

Correspondence Address: FORTKORT GRETHER + KELTON LLP, 9442 N. Capital of Texas Hwy., Suite 500, AUSTIN, TX, 78759, US

(73) Assignee: Update Publications LP

(21) Appl. No.: 11/232,305

(22) Filed: Sep. 21, 2005

Related U.S. Application Data
(60) Provisional application No. 60/612,242, filed on Sep. 22, 2004.

(51) Int. Cl. G06Q 99/00; G06F 7/00

(52) U.S. Cl. 705/1; 707/102

(57) ABSTRACT

A method for collecting, processing, and distributing residential data. Client accounts are established. A message is transmitted to the client accounts requesting the submission of primary residential data. The primary data is then received, including primary apartment data relating to apartment rental events and primary home data relating to home sale events. The primary residential data is normalized on a real-time basis to cause the primary apartment data and the primary home data of the resulting normalized primary residential data to be comparable on an equivalent basis. This equivalent basis can be described as an “apples-to-apples” to basis. Normalized secondary residential data is generated based on the normalized primary residential data on a real-time basis. The normalized secondary residential data and the normalized primary residential data is enabled to be accessed via a full-time public network on a real-time basis.

### FIELD

This disclosure pertains to a method and system for residential property data capture, process, and distribute on-line for sale or lease purposes.

### BACKGROUND

The effective collection and distribution of information is important to society. Effective collection and distribution provides an important element of infrastructure which supports the society's current efforts to progress through and ultimately conquer the Information Age.

Furthermore, the form in which information is collected is not always the form in which it is needed. Therefore, it can be highly advantageous to transform, or process, information before distributing it.

Thus, the effectiveness of methods and systems for the collection, processing, and distribution of information is of utmost concern to society.

While effective collection, processing, and distribution of information is an ongoing project of society, that project is necessarily limited by the technology available at any given time.

Before the use of technology to collect, process, and distribute information, a person simply used her senses to collect information, her memory and ability to think to process the information, and her power of speech to distribute the information. Later chalk and other writing utensils were used to enable drawing and writing as methods of distributing information. The information contained in these writings and drawings could then be collected by others for subsequent processing and distribution. Of course, human being inventive, technological leaps were made, ultimately culminating in the invention of paper and the printing press.

In recent decades we have seen the Internet come into common use by millions of people and businesses. Essentially, the Internet continues the evolutionary development of the technology supporting the collecting, processing, and distributing information.

Of course, the Internet has specific characteristics which make new techniques possible in the collection, processing, and distribution of information. The invention of such techniques serves to move society forward through the Information Age.

An example of an industry in which collection, processing, and distribution of information is clearly advantageous is the real estate market for new homes.

In the real estate market for new homes, there are two participants which are absolutely essential: home builders and home buyers. However, the market for new homes is relatively large. Due to the large number of homes on the market at any given time, a home buyer can become “lost” in the market, being unable to efficiently locate those homes which would most closely match the buyer's preferences.

This problem is not only felt by home buyers, but also by home builders. For while the home builder would theoretically be satisfied to sell to any buyer, in practice a home builder will be able to sell to a home buyer much more easily if the home matches the buyer's preferences. Therefore, home builders have a need to locate buyers having preferences sufficiently close to the homes built by the builder.

In response to the problems of home buyers and home builders in a large market of new homes, realtors evolved. The function of realtors is to collect information as to what homes are on the market and what preferences are possessed the realtor's home buyers, to process this information by matching buyers to homes as effectively and efficiently as possible, and to distribute the match information to the buyers in guiding them toward appropriate candidate homes.

As populations increase exponentially and even greater numbers of homes are built and placed on the market, the collection of information by the realtor becomes exponentially more difficult. When the realtor reaches his capacity to collect information about the home market, the response is typically to reduce the geographic area served, to reduce the depth of information collected about the area served, or both. Thus the level of service available from realtors to home buyers is constrained.

In an attempt to alleviate the constraint caused by the realtor's limited capacity to collect information, and thereby improve service levels to home buyers, a fourth type of participant began to play the role of “information collector” on behalf of the realtors. These information collectors collect information regarding the home market, process the information, and distribute it to realtors.

Various methods and systems are now used by information collectors in performing these tasks. Many information collectors access county property records and property tax records for information on home sales and process that information to enable distribution of that information to realtors in the form of a printed publication. This additional information can enable realtors to possess valuable information about the home sales market across a greater geographical area than would be possible without such an information collector.

However, county property records and property tax records typically reflect home sales that occurred months or more in the past. Therefore, the use of county property records and property tax records necessarily inserts a significant time delay into the process of collecting information about home sales by the realtor. Moreover, the time required to prepare a printed publication for distribution of the information from the information collector to the realtor results in additional delay.

Some information collectors now use the Internet to distribute home sales information to realtors, as well as directly to home buyers. This can help to reduce or even eliminate the delay attributable to preparing and delivering a printed publication.

However, many problems remain unsolved in the collection of home sales information to support realtors and other participants in the home sales market, one particular problem being a significant need to further reduce the amount of time required to collect home sales information, process that information, and distribute the information to realtors.

This disclosure provides such methods and systems. These and other advantages, as well as additional inventive features, will be apparent from the present disclosure.

### BRIEF DESCRIPTION OF THE DRAWINGS

For a more complete understanding of the present disclosure, and the advantages thereof, reference is now made to the following brief descriptions taken in conjunction with the accompanying drawings, in which like reference numerals indicate like features.

FIG. 1 illustrates a user interface, according to one embodiment taught by the present disclosure.

FIG. 2 illustrates a user interface, according to one embodiment taught by the present disclosure.

FIG. 3 illustrates a user interface, according to one embodiment taught by the present disclosure.

FIG. 4 illustrates a user interface, according to one embodiment taught by the present disclosure.

FIG. 5 illustrates a user interface, according to one embodiment taught by the present disclosure.

FIG. 6 illustrates a user interface, according to one embodiment taught by the present disclosure.

FIG. 7 illustrates a user interface, according to one embodiment taught by the present disclosure.

FIG. 8 illustrates a user interface, according to one embodiment taught by the present disclosure.

FIG. 9 illustrates a user interface, according to one embodiment taught by the present disclosure.

FIG. 10 illustrates a user interface, according to one embodiment taught by the present disclosure.

FIG. 11 illustrates a user interface, according to one embodiment taught by the present disclosure.

FIG. 12 illustrates a user interface, according to one embodiment taught by the present disclosure.

FIG. 13 illustrates a user interface, according to one embodiment taught by the present disclosure.

FIG. 14 illustrates a user interface, according to one embodiment taught by the present disclosure.

FIG. 15 illustrates a user interface, according to one embodiment taught by the present disclosure.

FIG. 16 illustrates a user interface, according to one embodiment taught by the present disclosure.

FIG. 17 illustrates a user interface, according to one embodiment taught by the present disclosure.

FIG. 18 depicts a block diagram of an overall system, according to one embodiment taught by the present disclosure.

FIG. 19 depicts a schematic diagram of a data entry interface, according to one embodiment taught by the present disclosure.

FIG. 20 depicts a block diagram of an overall system, according to one embodiment taught by the present disclosure.

FIG. 21 depicts a flowchart showing an information collection process, according to one embodiment taught by the present disclosure.

FIG. 22 depicts a schematic diagram of a data structure for collected information, according to one embodiment taught by the present disclosure.

FIG. 23 depicts a block diagram of an overall system, according to one embodiment taught by the present disclosure.

FIG. 24 depicts a block diagram of a process for authorization of a master account and sub-accounts, according to one embodiment taught by the present disclosure.

FIG. 25 depicts a block diagram of logical relationships within an overall system, according to one embodiment taught by the present disclosure.

FIG. 26 depicts a flowchart showing a process of collecting, processing, and distributing apartment and home data, according to one embodiment taught by the present disclosure.

FIG. 27 depicts a flowchart showing a messaging process, according to one embodiment taught by the present disclosure.

FIG. 28 depicts a flowchart showing a process of merging and normalizing home and apartment data, according to one embodiment taught by the present disclosure.

FIG. 29 depicts a flowchart showing a real-time information distribution process, according to one embodiment taught by the present disclosure.

FIG. 30 depicts a flowchart showing a process for implementing community, according to one embodiment taught by the present disclosure.

FIG. 31 depicts a block diagram of community relationships, according to one embodiment taught by the present disclosure.

FIG. 32 depicts a Site Welcome Page user interface, according to one embodiment taught by the present disclosure.

FIG. 33 depicts a Locator Registration user interface, according to one embodiment taught by the present disclosure.

FIG. 34 depicts a Supervisor or Area Supervisor Home Page user interface, according to one embodiment taught by the present disclosure.

FIG. 35 depicts a Manager's View of an Apartment Community Home Page user interface, according to one embodiment taught by the present disclosure.

FIG. 36 depicts a Selection Filter and Batch Update for Apartment Information user interface, according to one embodiment taught by the present disclosure.

FIG. 37 depicts an Information Details for an Individual Apartment Home user interface, according to one embodiment taught by the present disclosure.

FIG. 38 depicts a Form—Edit Apartment Home Information user interface, according to one embodiment taught by the present disclosure.

FIG. 39 depicts a View Lease History for an Apartment Home user interface, according to one embodiment taught by the present disclosure.

FIG. 40 depicts a View Lease Details user interface, according to one embodiment taught by the present disclosure.

FIG. 41 depicts a Renew a Lease for an Apartment Home user interface, according to one embodiment taught by the present disclosure.

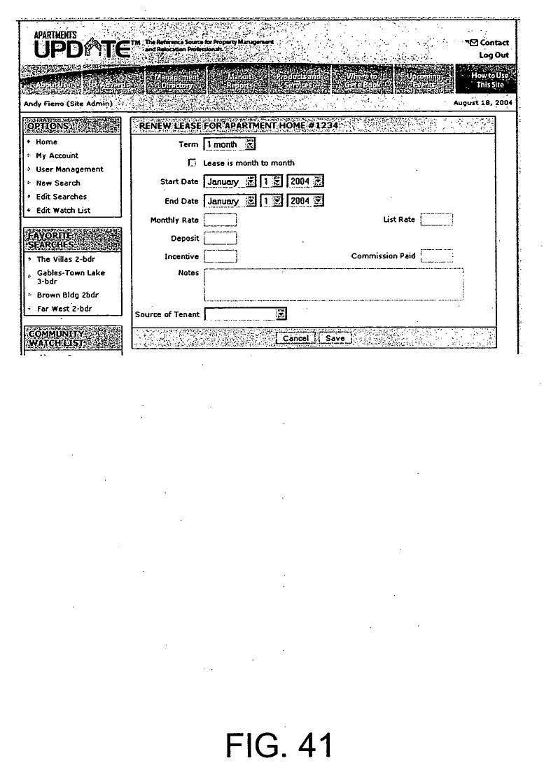

FIG. 42 depicts an Edit Lease Information for an Apartment Home user interface, according to one embodiment taught by the present disclosure.

FIG. 43 depicts a Locator Home Page user interface, according to one embodiment taught by the present disclosure.

FIG. 44 depicts an Advanced Search for Available Apartment Homes user interface, according to one embodiment taught by the present disclosure.

FIG. 45 depicts a Locator's View of an Apartment Community Home Page user interface, according to one embodiment taught by the present disclosure.

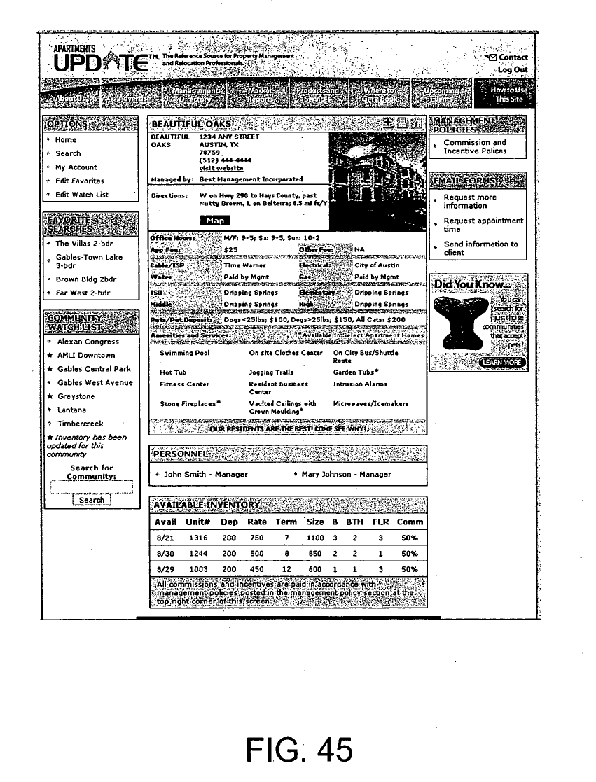

FIG. 46 depicts a Locator's View of Commission Policies and Guidelines user interface, according to one embodiment taught by the present disclosure.

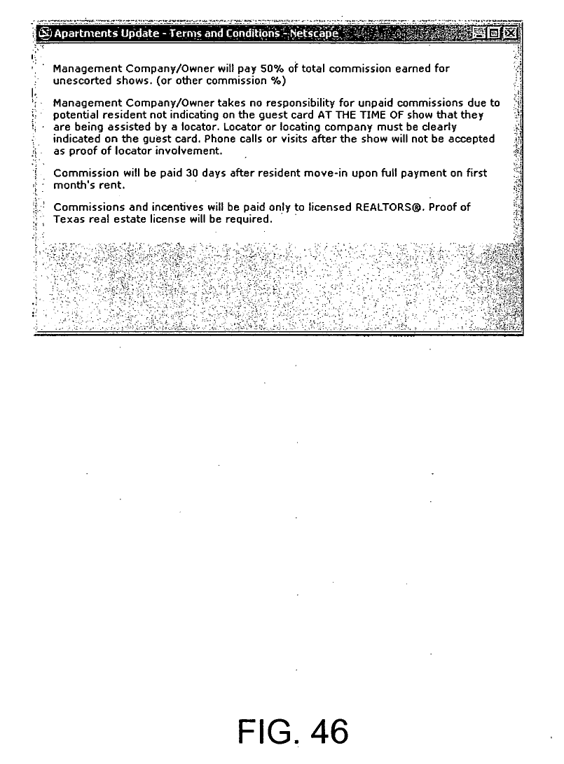

FIG. 47 depicts a Site Admin Home Page user interface, according to one embodiment taught by the present disclosure.

FIG. 48 depicts a Form—Add Property Management Company user interface, according to one embodiment taught by the present disclosure.

FIG. 49 depicts a Search for User Form and Resulting User List user interface, according to one embodiment taught by the present disclosure.

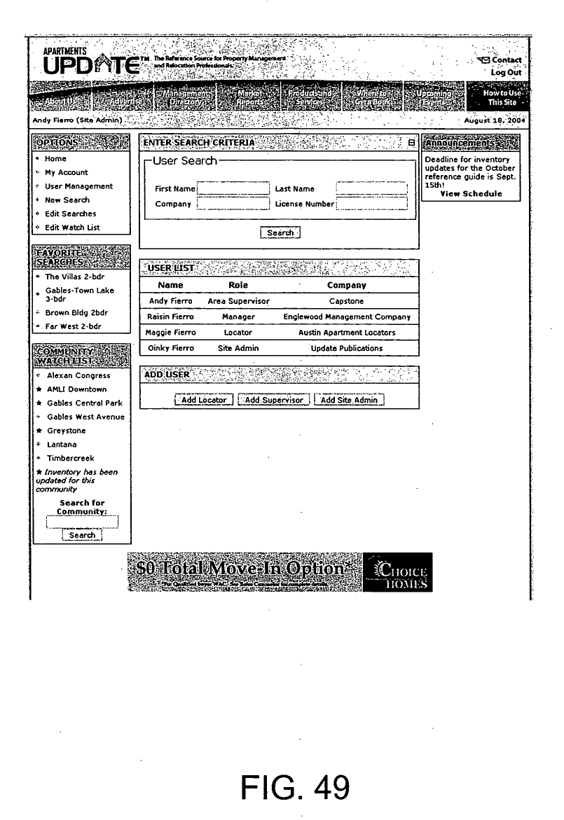

FIG. 50 depicts a Form—Edit User Information user interface, according to one embodiment taught by the present disclosure.

FIG. 51 depicts a Property Management Company Home Page user interface, according to one embodiment taught by the present disclosure.

FIG. 52 depicts a Form—Add Apartment Community user interface, according to one embodiment taught by the present disclosure.

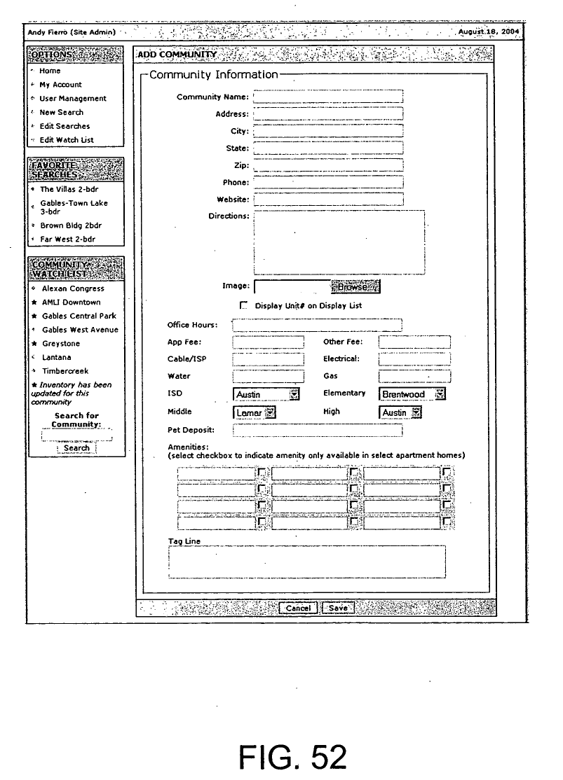

FIG. 53 depicts a Form—Add Apartment Home user interface, according to one embodiment taught by the present disclosure.

FIG. 54 depicts a Sample Report, according to one embodiment taught by the present disclosure.

### DETAILED DESCRIPTION

This disclosure provides a method for collecting, processing, and distributing residential data. Client accounts are established. A message is transmitted to the client accounts requesting the submission of primary residential data. The primary data is then received, including primary apartment data relating to apartment rental events and primary home data relating to home sale events. The primary residential data is normalized on a real-time basis to cause the primary apartment data and the primary home data of the resulting normalized primary residential data to be comparable on an equivalent basis. This equivalent basis can be described as an “apples-to-apples” to basis. Normalized secondary residential data is generated based on the normalized primary residential data on a real-time basis. The normalized secondary residential data and the normalized primary residential data is enabled to be accessed via a full-time public network on a real-time basis.

This disclosure also provides a computer-readable signal capable of being propagated across a full-time public network, the signal carrying computer-readable instructions executable for enabling the performing of a method for collecting data to facilitate real time access and efficient reporting. A sub-account is authorized by a master account, via the full-time public network, to submit primary data associated with a set of residential property. A reminder message is transmitted to the sub-account requesting that the sub-account submit the primary data. The primary data is received from the sub-account via the full-time public network. A known inquiry is received from a remote computer user via the full-time public network. Real-time secondary data at least partially based on the primary data is transmitted to the remote user via the full-time public network.

In addition, this disclosure teaches a method in a computer system having storage, for facilitating normalized merging of data relating to rental and sales of apartments and homes. Collective data is received which includes apartment data having records relating to rental and sales of apartments and home data having records relating to rental and sales of homes. A standard unit of measurement is provided. The standard unit of measurement is suitable for at least partially describing the apartment data and for at least partially describing the home data. The collective data is normalized based on at least one component of the collective data. As a result, the records of the apartment data can be compared to the records of the home data on an equivalent basis. The term “equivalent basis” is intended to convey the meaning of an “apples-to-apples” basis of comparison.

The disclosure also teaches a method for facilitating real time access across a full-time public network and efficient reporting functionality. Pre-existing data is provided in a database server which is communicably coupled to the full-time public network. Fresh data is received via the full-time public network and recorded on a real-time basis in the database server. Access to the database server by the submission of one or more queries originating from client computing devices is enabled across the full-time public network. In response to such a query real-time return data is provided corresponding to the query, wherein the real-time return data is based on at least a portion of the collective of the pre-existing data and the fresh data.

Furthermore, the disclosure teaches a method for facilitating complex relationship-based interactions among computer-using members of a community, corresponding to a set of computer-using clients. A database system communicably coupled to a full-time, public network is provided, wherein the database system includes collection and distribution functionalities and is configured to make the functionalities accessible via the full-time, public network. Data is recorded in said database defining the community and associating a manager with the community, wherein the manager is a member of the community. The manager is enabled to invite others to join the community in order to become additional members of the community. The manager is enabled to establish common approval items with regard to which two specific members must agree in order to make a decision. The database system is enabled to collect data from the members via the full-time public network. The database system is enabled to receive at least one query from at least one member via the full-time public network. The database system is enabled to distribute data to the members in response to the query via the full-time public network.

Other aspects, objectives and advantages of the invention will become more apparent from the remainder of the detailed description when taken in conjunction with the accompanying drawings.

The present disclosure includes teachings of methods and systems for the collection, processing, and distribution of information related to home sales and apartment rentals, and inventive portions thereof.

Utilization of a full-time public network allows efficient, convenient, and timely collection of home sales and apartment rental information. A client-server model may be used to leverage the full-time public network. But peer-to-peer and other models may be used advantageously in various circumstances and configurations.

Implementation of master accounts and sub-accounts can allow a reduction in the workload and delay involved in collecting information because sub-accounts can be empowered to directly submit information to be collected. Contrast this with submission of information from sub-accounts to a master account for review, followed by submission of the information from the master account for collection. Compound this example with the information coming from the sub-accounts to the master account in a format different from that required to be submitted by the master account for collection.

Reminder messages provide greater and more timely collection of information from master accounts and sub-accounts. For example, a home builder operating as a sub-account can be reminded to submit home sales information for the last week, reducing the likelihood that the home builder will allow additional time to pass before submitting that information.

Merging home sales and apartment rental information provides a great value to people in the market for a residence —i.e., being presently undecided between home ownership and apartment rental. Such merging requires the data to be normalized so that meaningful “apples-to-apples” comparisons can be made. For example, home acquisition and ownership costs can be computationally transformed into information equivalently comparable to apartment rental rates and lease terms. Likewise, apartment rental rates and lease terms can be computationally transformed into information equivalently comparable to home acquisition and ownership costs.

Throughout this application, reference is made to “home sales” and “apartment rental.” However, those terms and related terms as they are used herein include “home sales,” “home rental,” “apartment unit rental,” “apartment unit sales,” as well as the sale or rental of condominiums or other residential units, such as residential time shares.

Likewise, the term home builder and alternative terms are used throughout this disclosure. Those terms are intended to encompass home builders, onsite-managers, new home investors, rental managers, condominium distributors, and any others who engage in selling or renting residential space, whether homes, apartments, or otherwise. Similarly, the term realtor is used to indicate anyone who would benefit by receiving the distributed information.

Real-time distribution of information depends upon timely performance of all required stages of collecting, processing, and distributing the information. Delays in the process serve to reduce the capability to provide information that is real-time. Conversely, a real-time distribution system or method could allow a home builder to submit information for collection on Friday evening which then influences the purchase decision of a home buyer that weekend who is being assisted by a realtor who accessed the newly submitted information.

Likewise, customized querying by information distribution recipients is enabled because information would be available real-time. This would enable customized reports to be generated containing the specific information desired by recipients. Alternatively, standard reports could be provided by email on a daily or even hourly basis, for example, rather than quarterly or monthly.

Implementation of communities allows groups of home builders and realtors to form in order to share information, preferences, and other channels, features, and mechanisms without cross-sharing all aspects of those channels, features, and mechanisms with all other home builders and realtors. Thus, communities can create heightened levels of usability, convenience, and efficiencies.

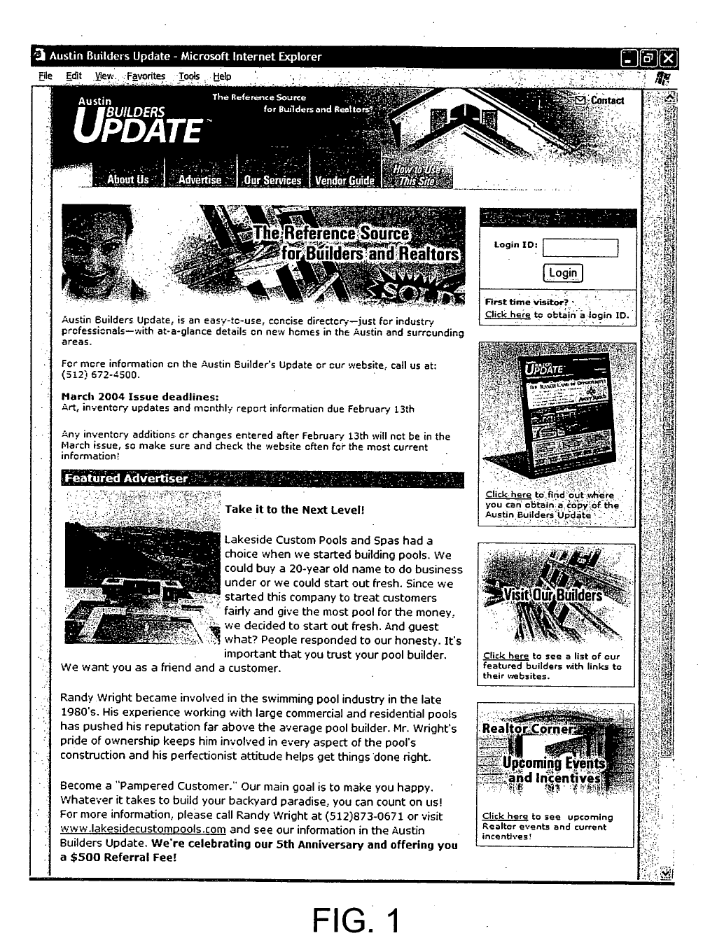

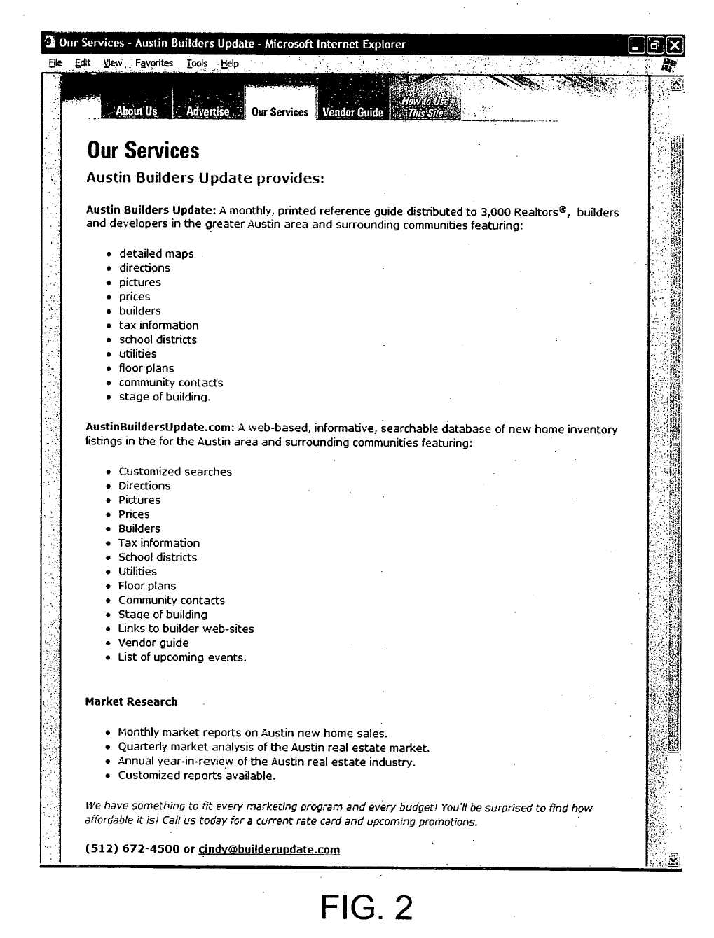

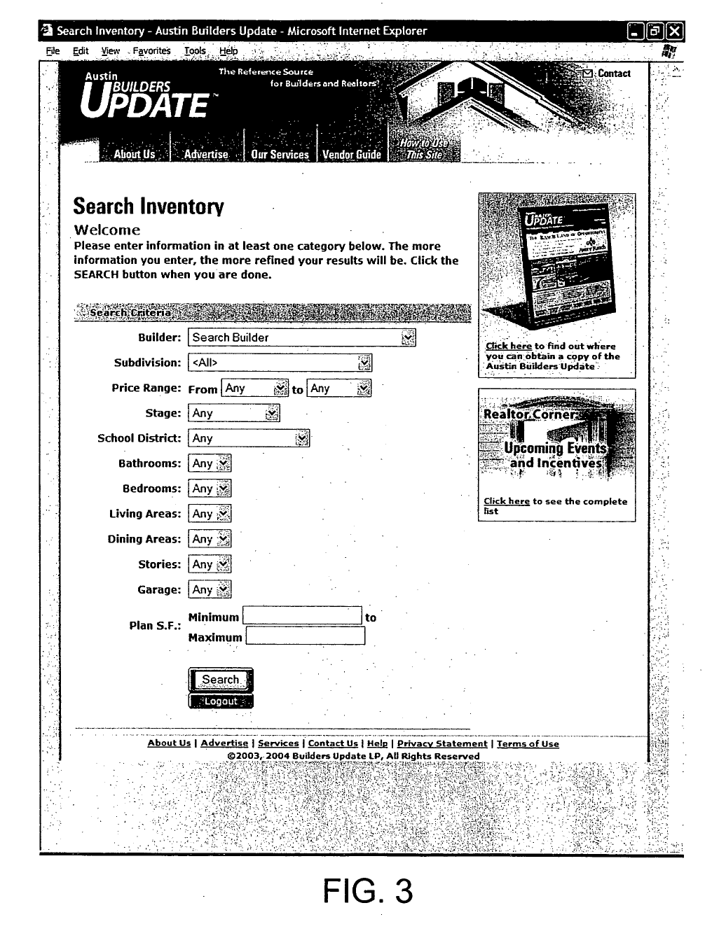

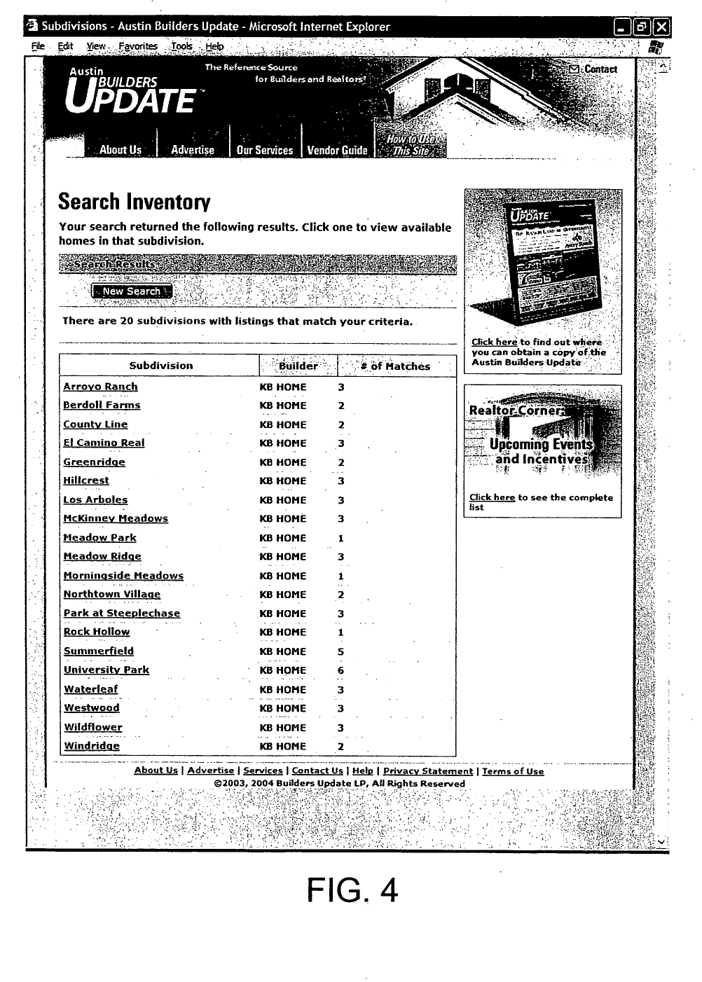

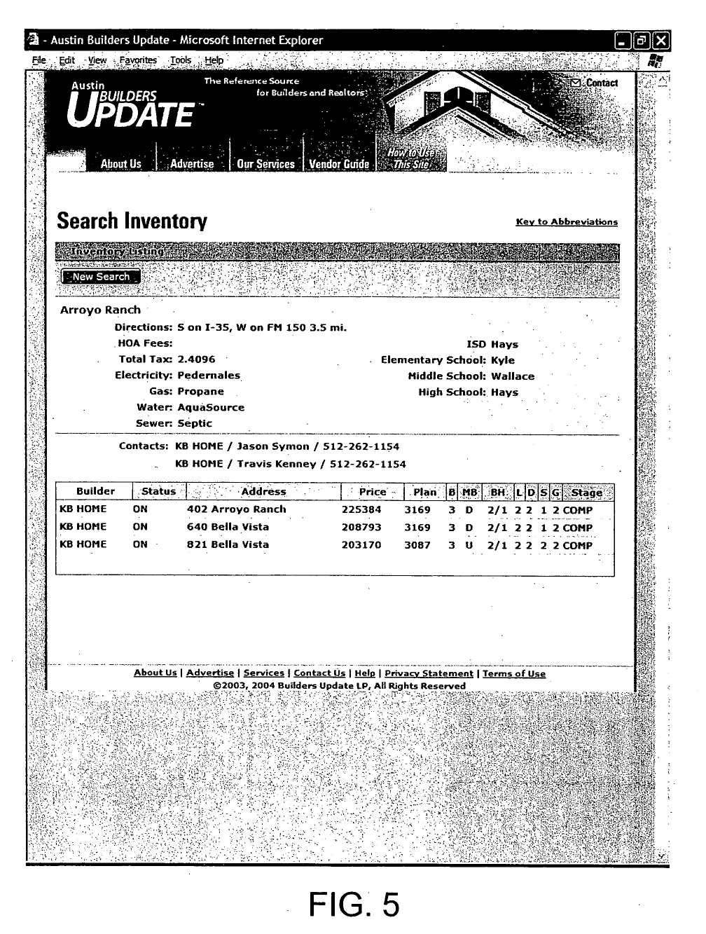

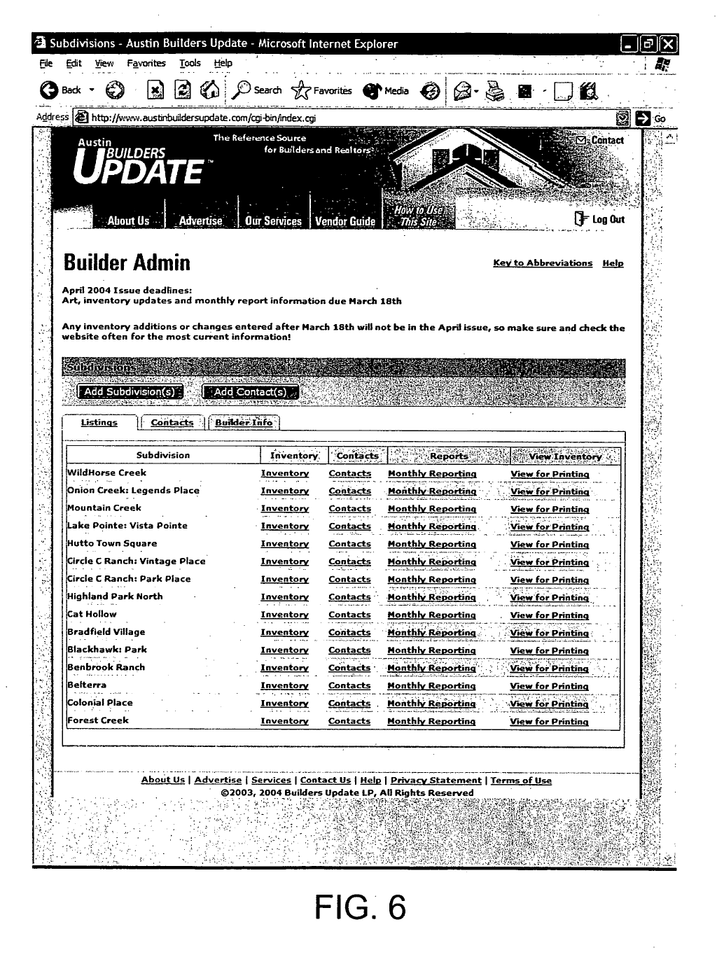

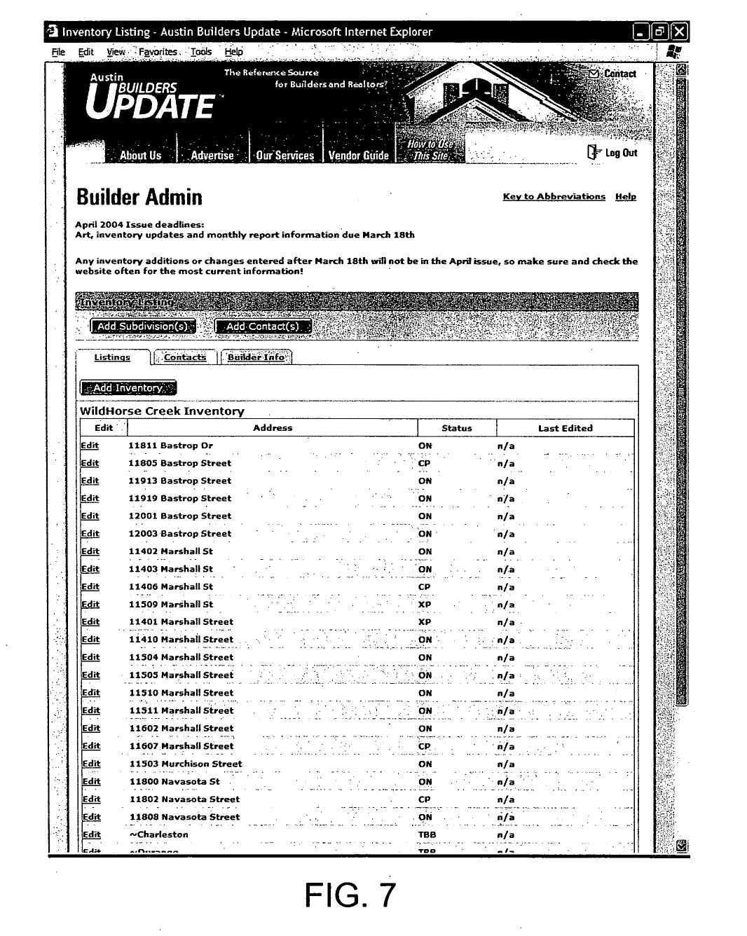

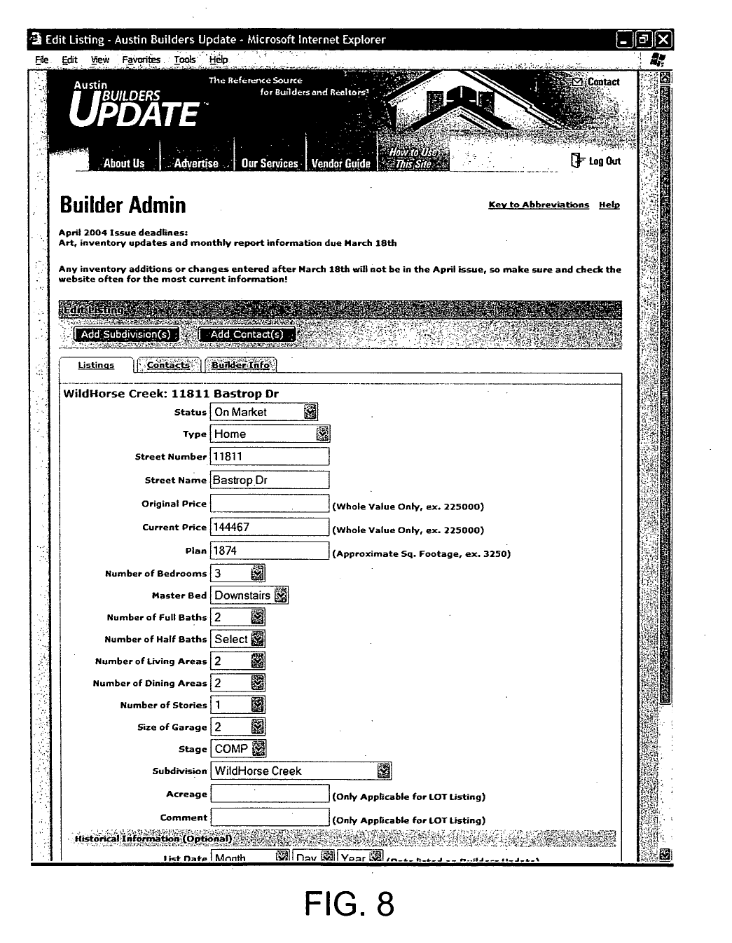

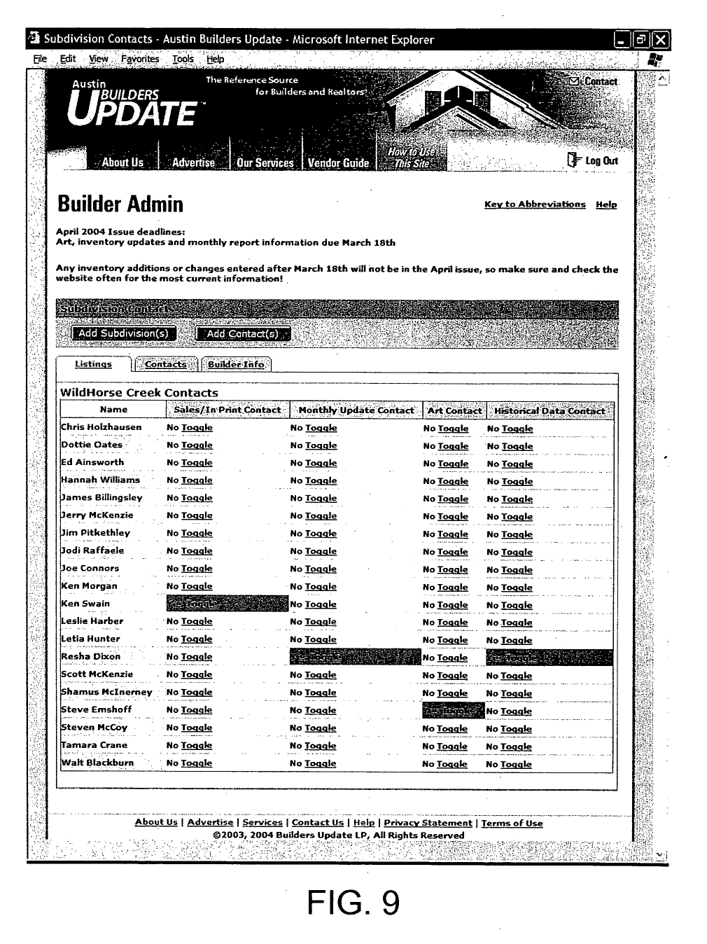

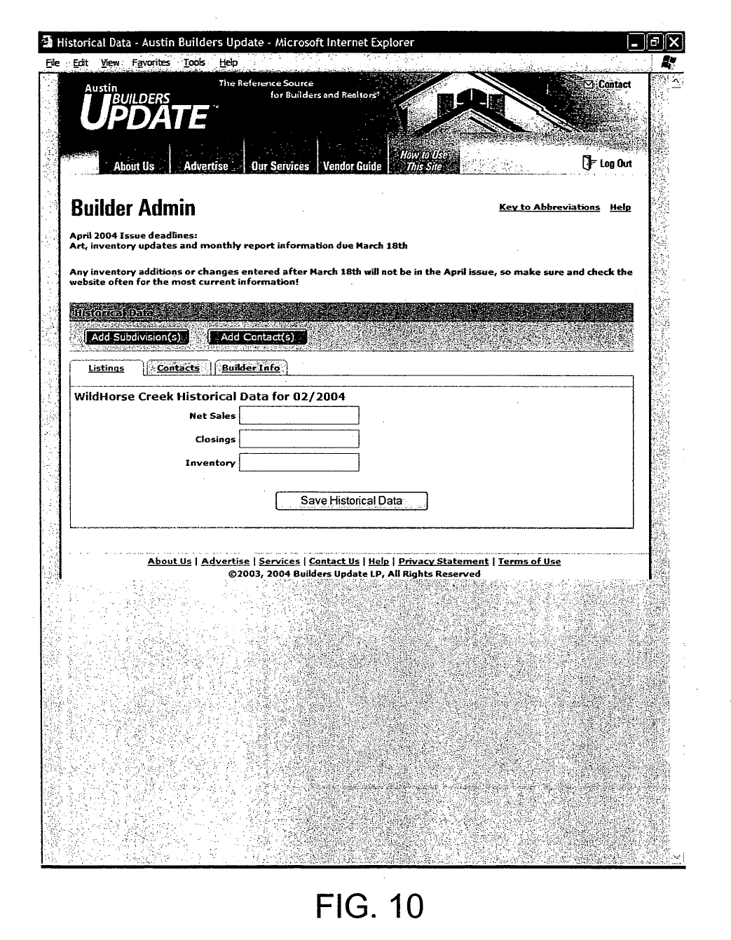

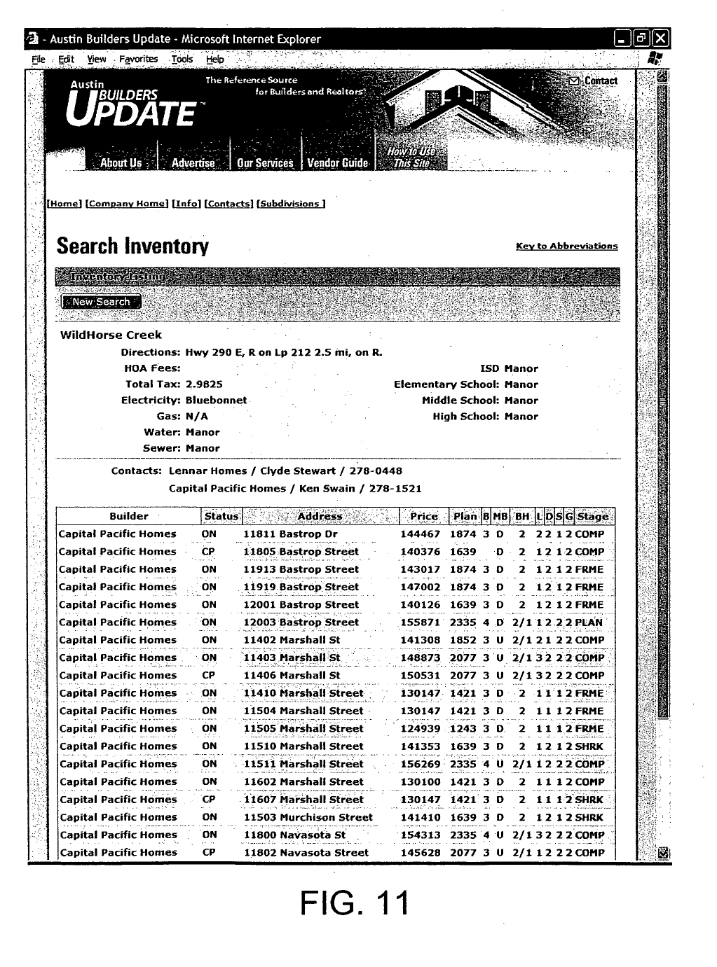

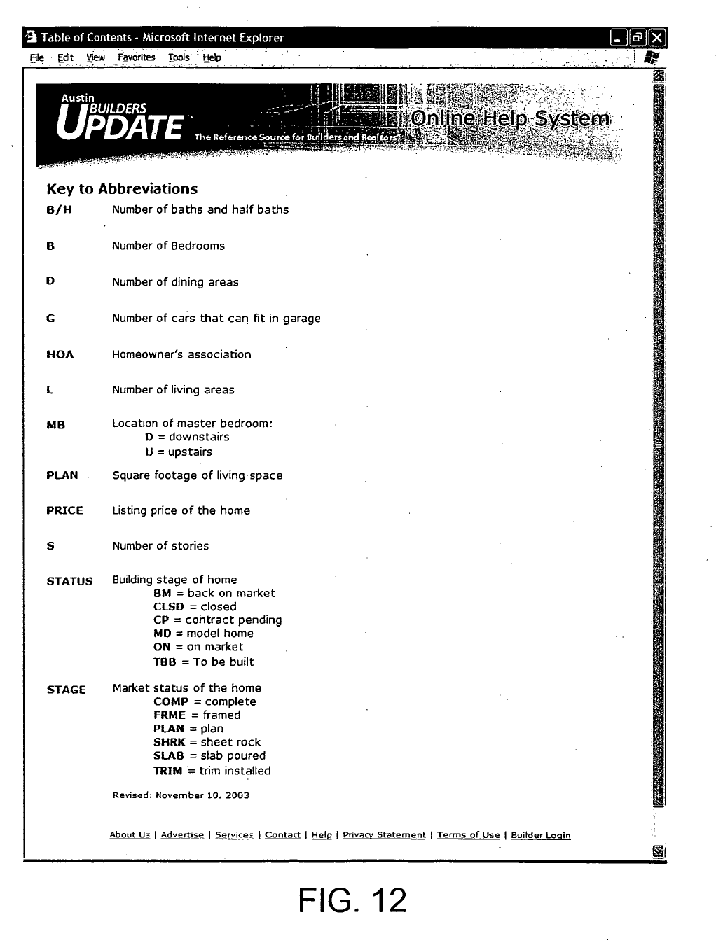

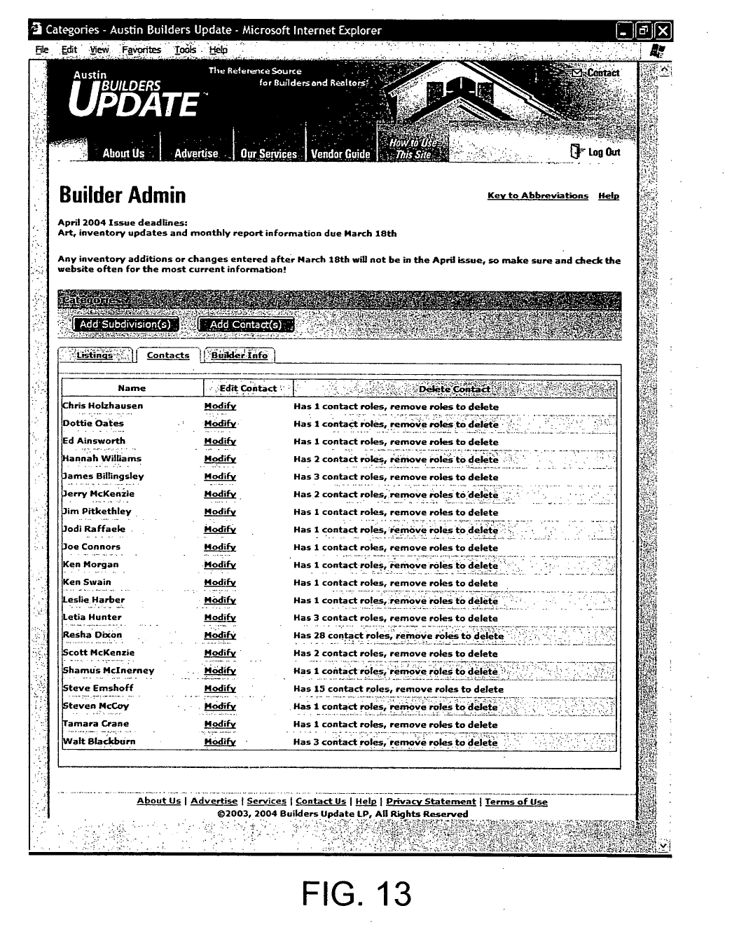

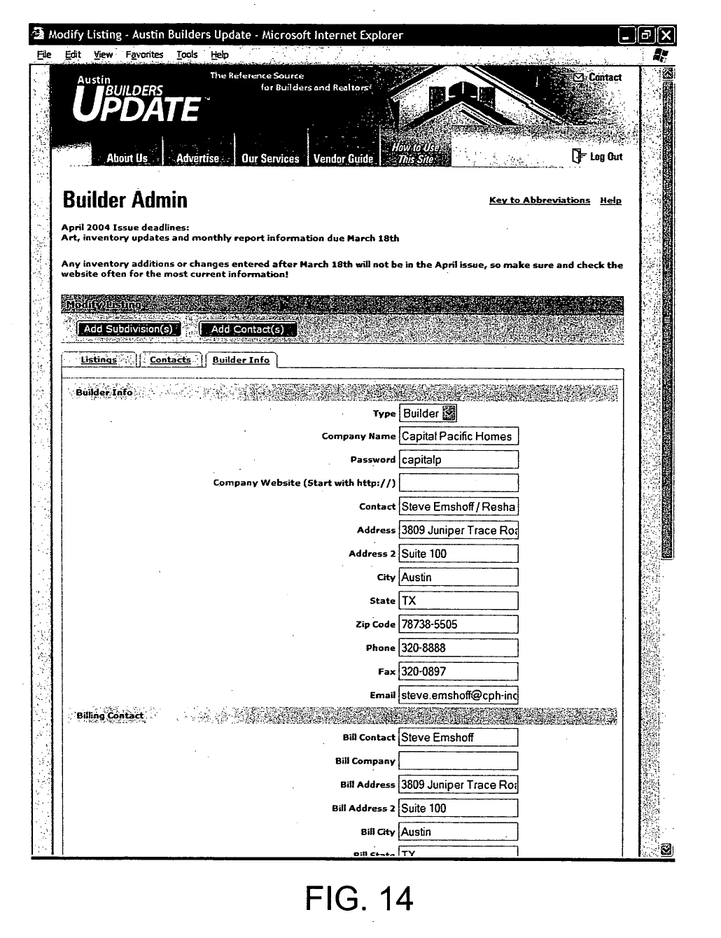

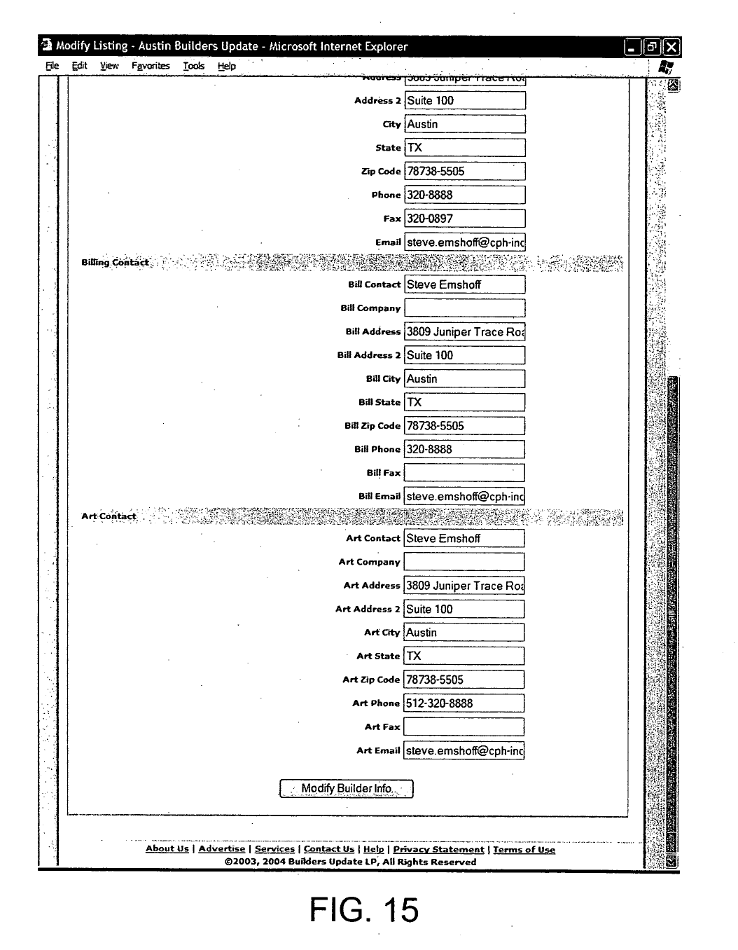

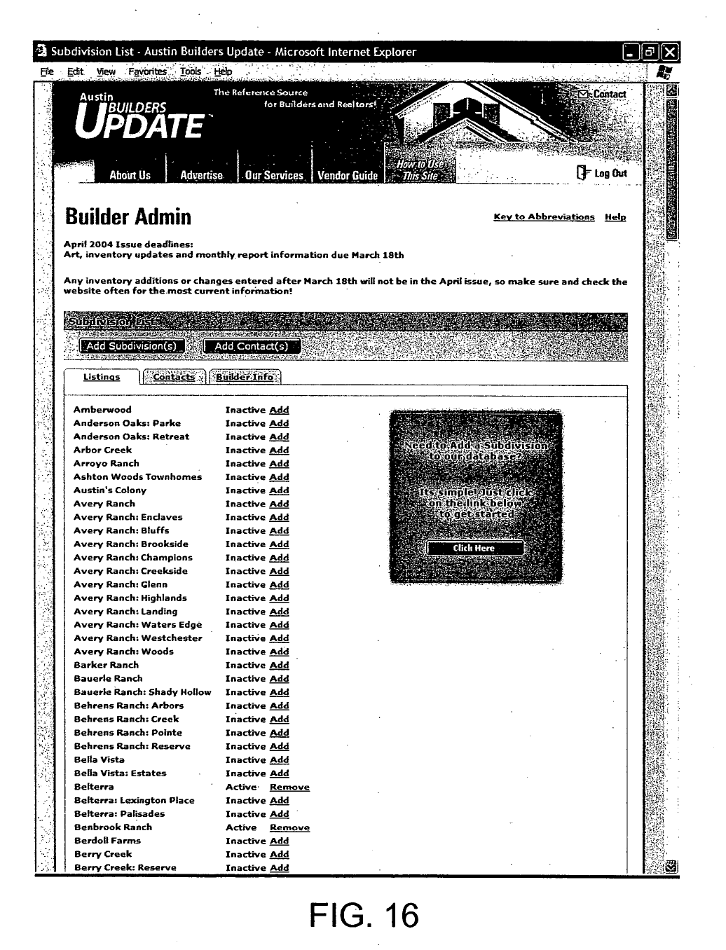

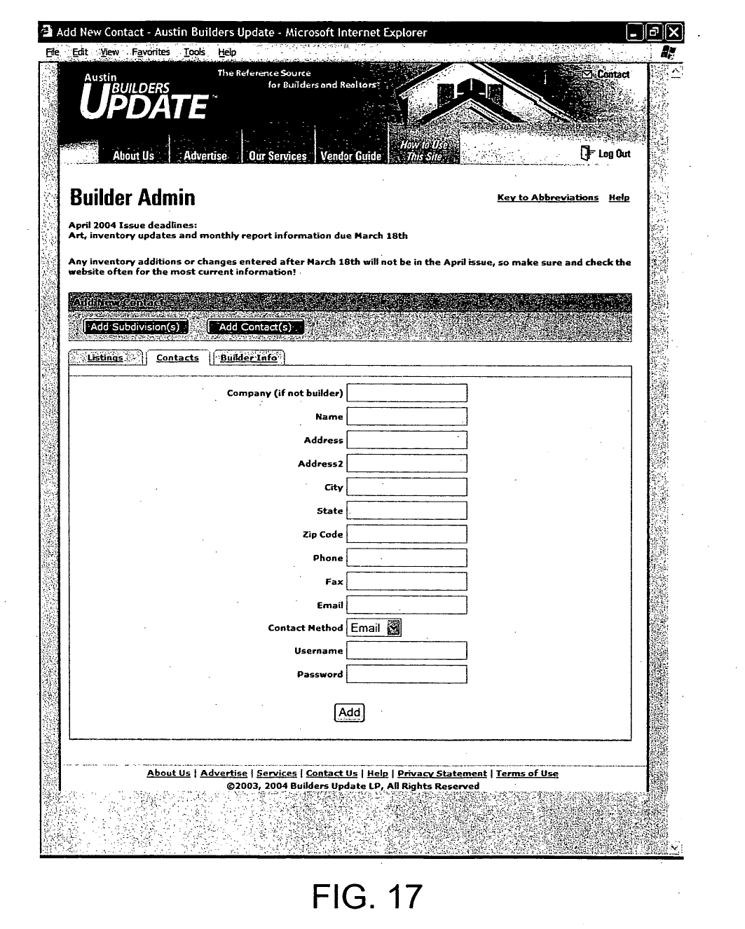

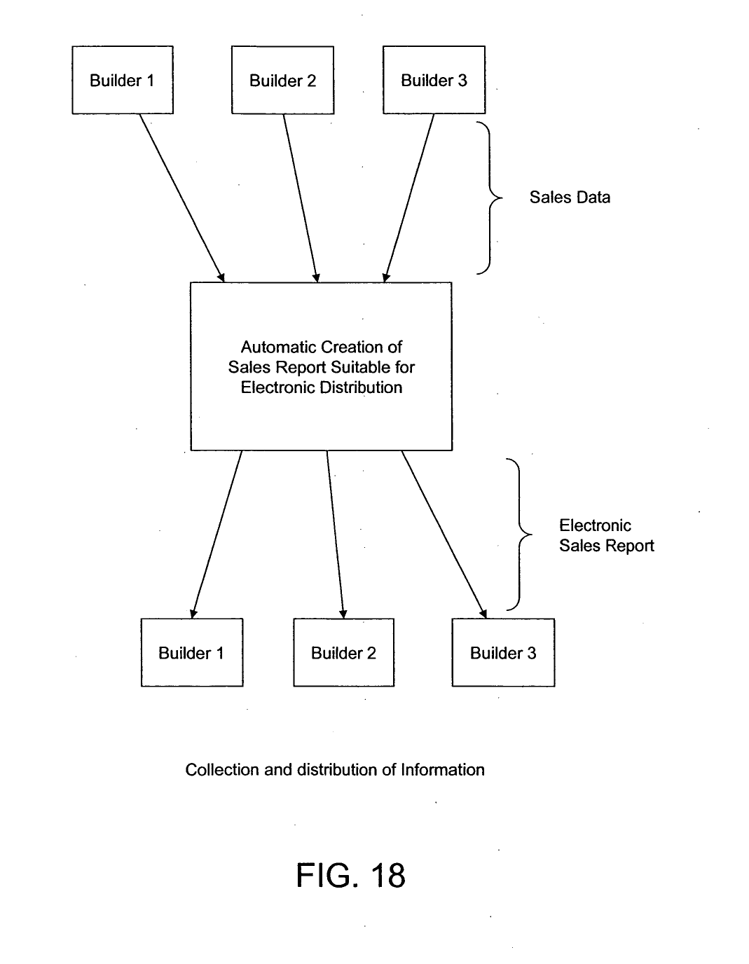

Turning to the drawings, FIGS. 1-17 depict user interfaces through which home builders and realtors might interact with the disclosed systems and methods. The remaining drawings, FIGS. 18-26, depict block diagram examples of some systems and methods.

FIG. 18 depicts a block diagram of an overall system, according to one embodiment taught by the present disclosure. Three builders are depicted inputting sales data. Automatic creation of a sales report suitable for electronic distribution is also shown. Finally, distribution of the report to three builders is shown.

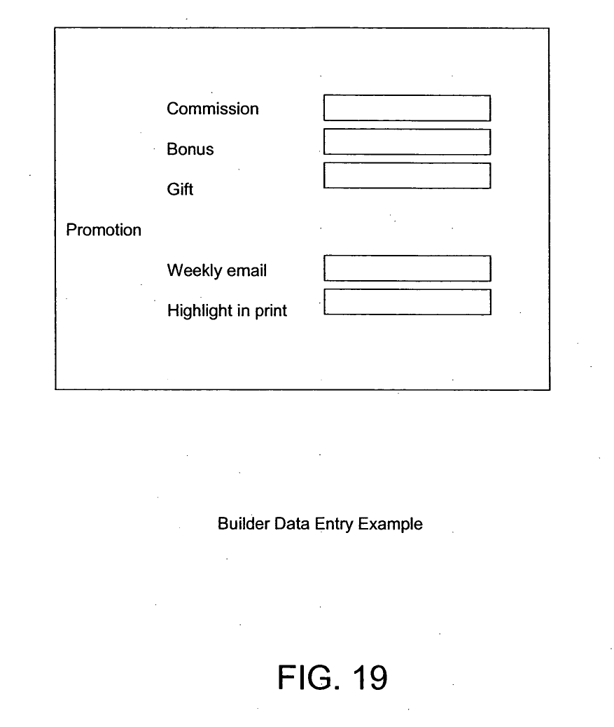

FIG. 19 depicts a schematic diagram of a data entry interface, according to one embodiment taught by the present disclosure. The data entry interface includes entries for the builder to enter commission, bonus, and gift, as well as weekly email promotion and which homes to highlight in print.

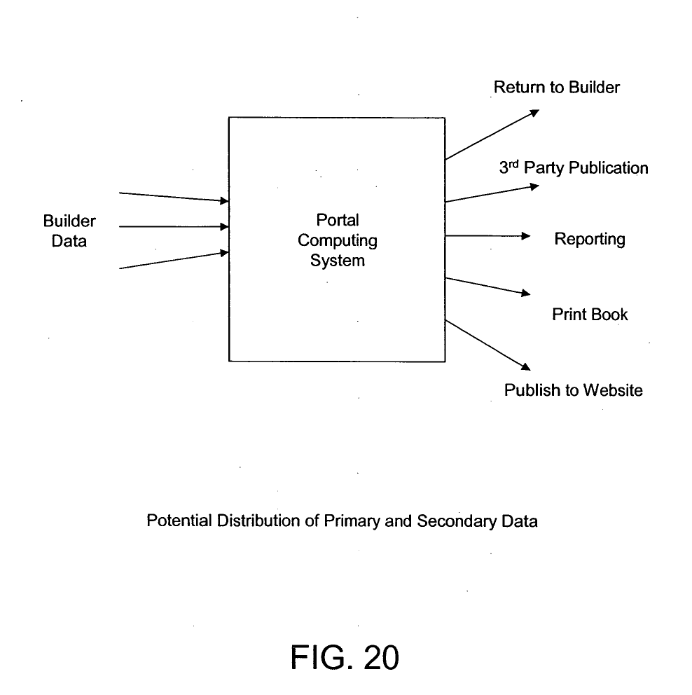

FIG. 20 depicts a block diagram of an overall system, according to one embodiment taught by the present disclosure. The figure illustrates the capability of the system to collect data from multiple builders and distribute data to multiple recipients, including the submitting builders, 3^{rd} parties for publication, reporting channels such as email, pre-printing process for inclusion in a printed publication, and publishing to a web site.

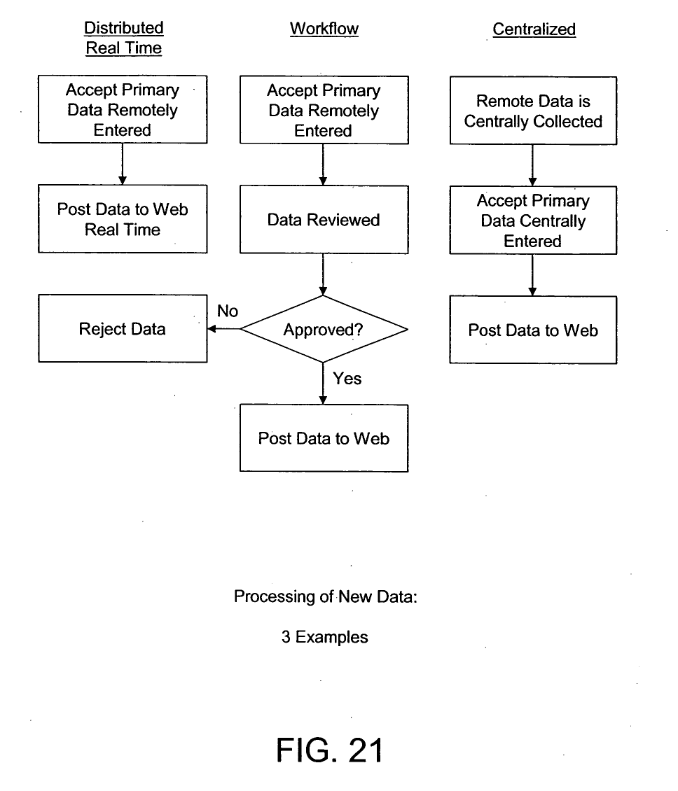

FIG. 21 depicts a flowchart showing an information collection process, according to one embodiment taught by the present disclosure. Data is shown to be distributed real-time, via a managed workflow, or according to a centralized model. Where data is distributed real-time, primary data is accepted as remotely entered and posted real-time on the Web site or other distribution channel. Where data is distributed via a managed workflow, primary is accepted as remotely entered, but it is then subject to a review stage. The review stage can result in the data being either rejected or accepted. In the latter event, the data is posted to the Web site or other distribution channel. Where data is distributed according to a centralized model, remote data is centrally collected, centrally entered, and then posted to the Web site or other distribution channel.

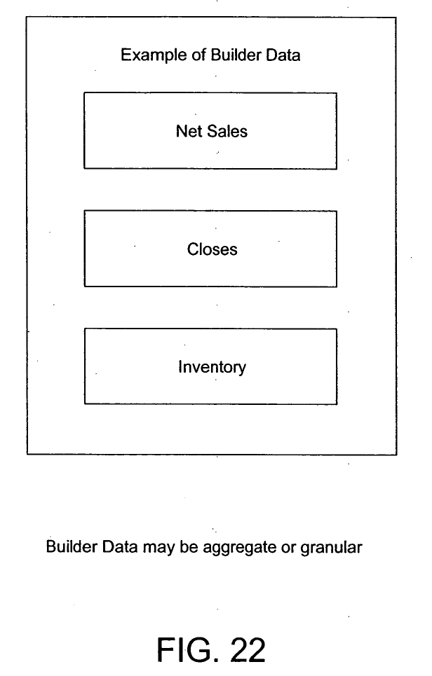

FIG. 22 depicts a schematic diagram of a data structure for collected information, according to one embodiment taught by the present disclosure. The example of builder data includes net sales, closes, and inventory. The information may be more granular or more aggregate, depending on what is collected and how it is processed.

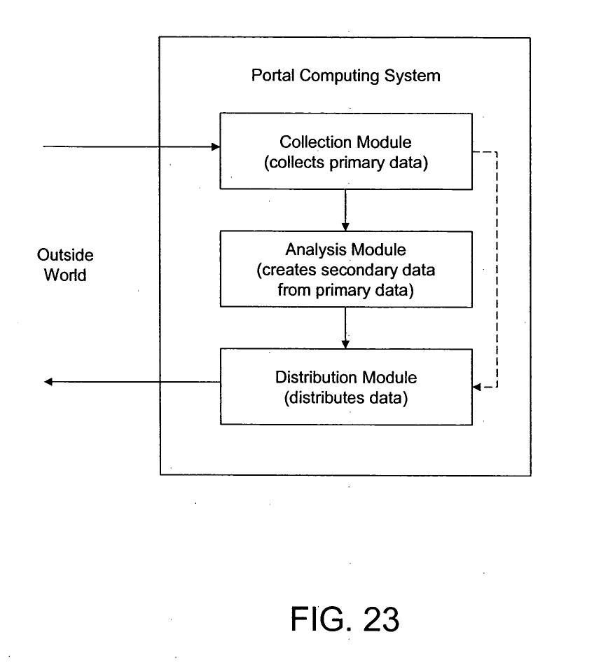

FIG. 23 depicts a block diagram of an overall system, according to one embodiment taught by the present disclosure. The portal computing system collects primary data into a collection module, an analysis module processes the data to create secondary data, and a distribution module distributes data out of the portal computing system.

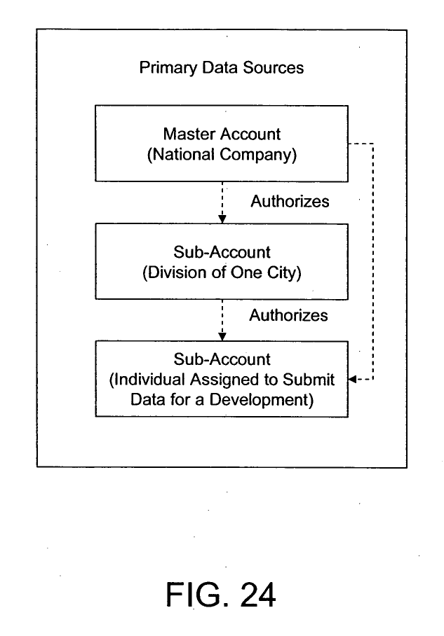

FIG. 24 depicts a block diagram of a process for authorization of a master account and sub-accounts, according to one embodiment taught by the present disclosure. Primary data sources are shown to be a master account and sub-accounts. In the example, the master account represents a national company. The sub-accounts represent a division of one city and an individual assigned to submit data for a development. In the example, the master account authorizes the first sub-account, while the first sub-account authorizes the second sub-account. Alternatively, also shown in the example, the master account authorizes both sub-accounts.

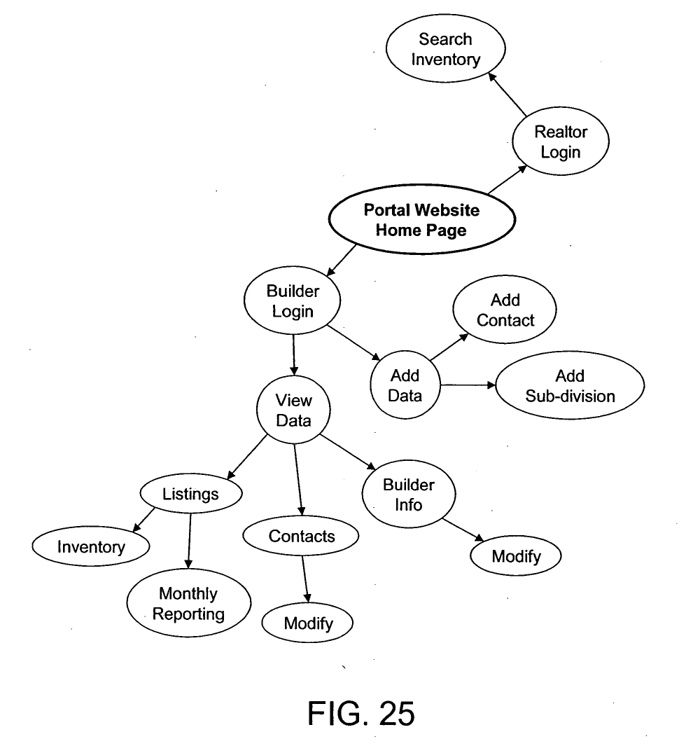

FIG. 25 depicts a block diagram of logical relationships within an overall system, according to one embodiment taught by the present disclosure. A portal website home page is shown. Stemming therefrom are a variety of pages selected for this example which enable collection and distribution of information.

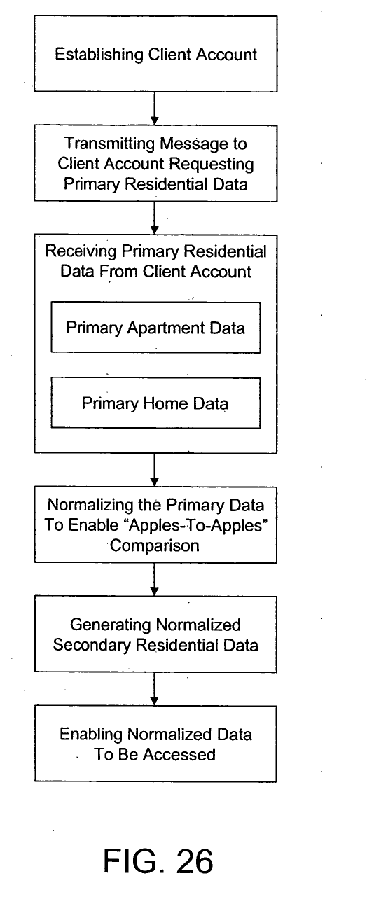

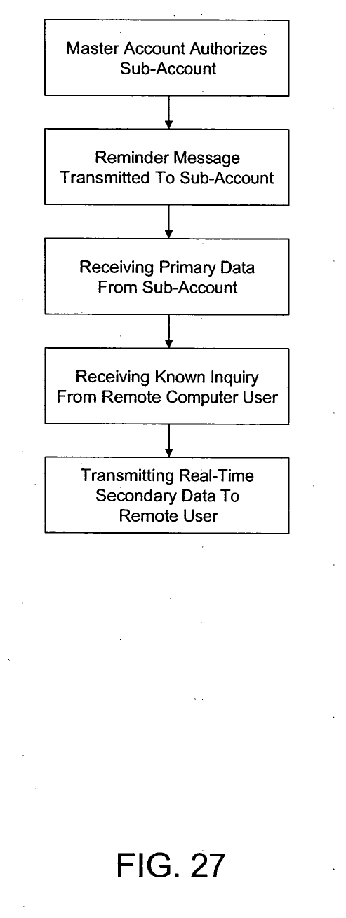

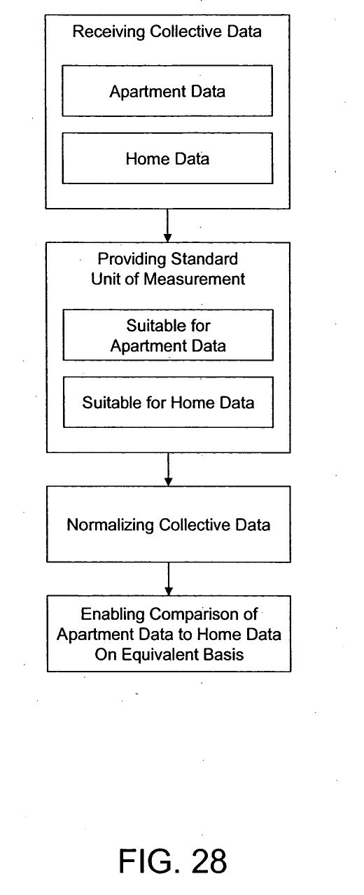

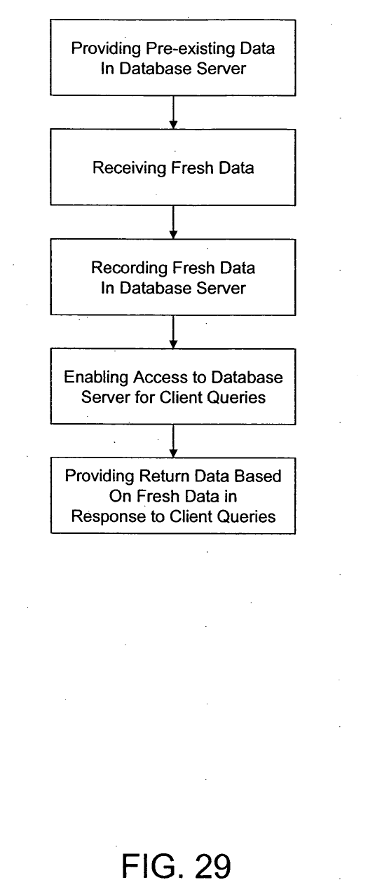

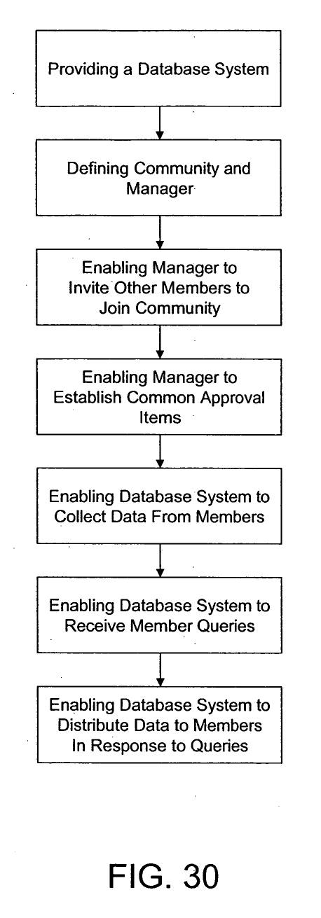

FIG. 26 depicts a flowchart showing a process of collecting, processing, and distributing apartment and home data, according to one embodiment taught by the present disclosure. FIG. 27 depicts a flowchart showing a messaging process, according to one embodiment taught by the present disclosure. FIG. 28 depicts a flowchart showing a process of merging and normalizing home and apartment data, according to one embodiment taught by the present disclosure. FIG. 29 depicts a flowchart showing a real-time information distribution process, according to one embodiment taught by the present disclosure. FIG. 30 depicts a flowchart showing a process for implementing community, according to one embodiment taught by the present disclosure.

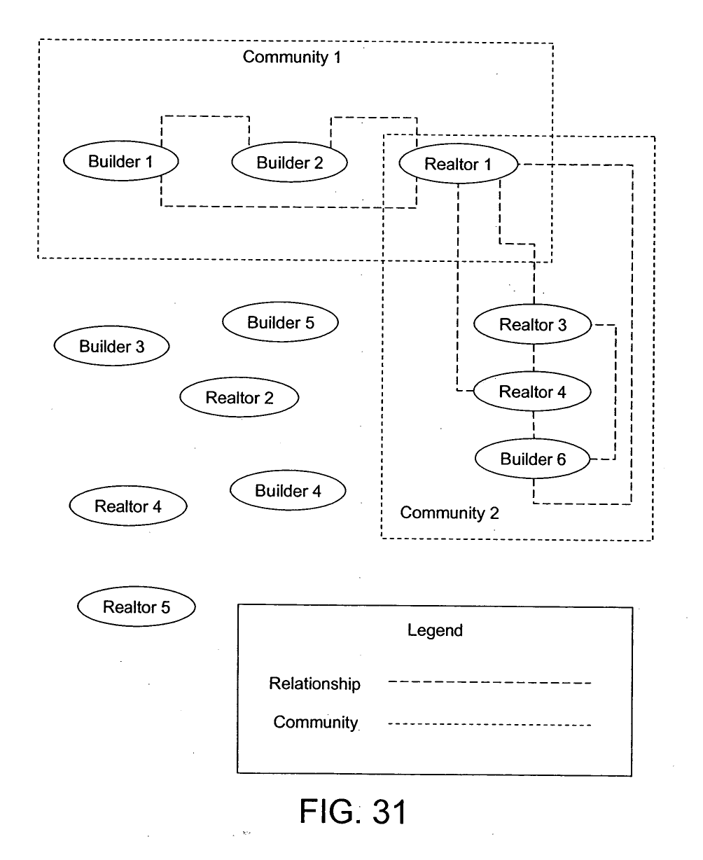

FIG. 31 depicts a block diagram of community relationships, according to one embodiment taught by the present disclosure. Six builders, five realtors, and two communities are shown. Builders 1 and 2 and Realtor 1 are in the first community. Each member of the first community is therefore related to each of the other members of the first community. Builder 6 and Realtors 1, 3, and 4 are in the second community. Note that Realtor 1 is in both communities. Builders 3, 4, and 5 and Realtors 2, 4, and 4 are not members of either community.

Another example of community is a single-seller community implementation. In this example, one builder or apartment manager creates a community. The creator then invites one or more buyers or buyer agents, such as realtors, to join the community as members. The creator makes certain proprietary information available to the members, but not to the general public. In this way, a closer business relationship can be fostered between the creator and the members built on an enhanced flow of information while protecting certain proprietary information of the creator.

Another embodiment taught by the present disclosure is an on-line apartment updating service operated by a publisher. It is contemplated that the embodiment be hosted on the World Wide Web and thus be accessible to administrators, apartment managers, apartment supervisors, and apartment locators via the Internet. Many of the aspects of this example are well-suited to implementation in an analogous embodiment which focuses on sales of residential property, such as houses, rather than on leasing of residential property, such as apartments. Some differences between the two embodiments will be noted below, but other differences, and most similarities, between the two embodiments, while not explicitly stated, will otherwise be understood by those skilled in the art.

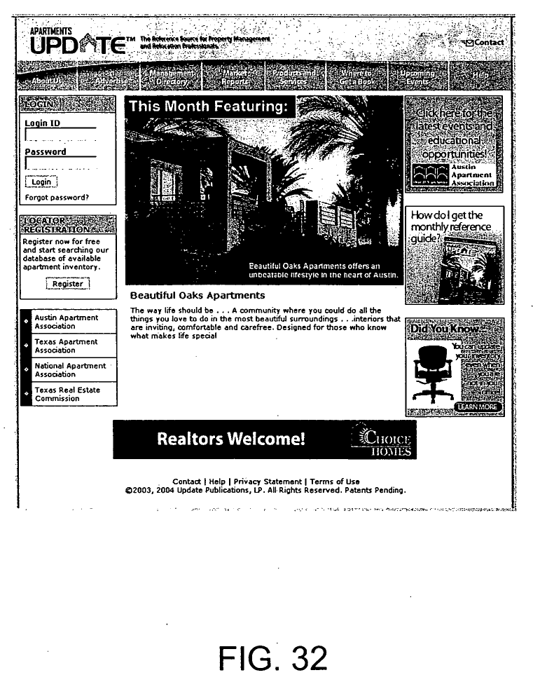

User Login and Access Control is addressed in that access to areas of the site containing data about apartment communities, property management companies, or individual users is restricted to registered users. Registered users gain access to the site by logging in. (FIG. 32, upper left) The site uses the user's specified email address as his user ID. The user's password is set by the user.

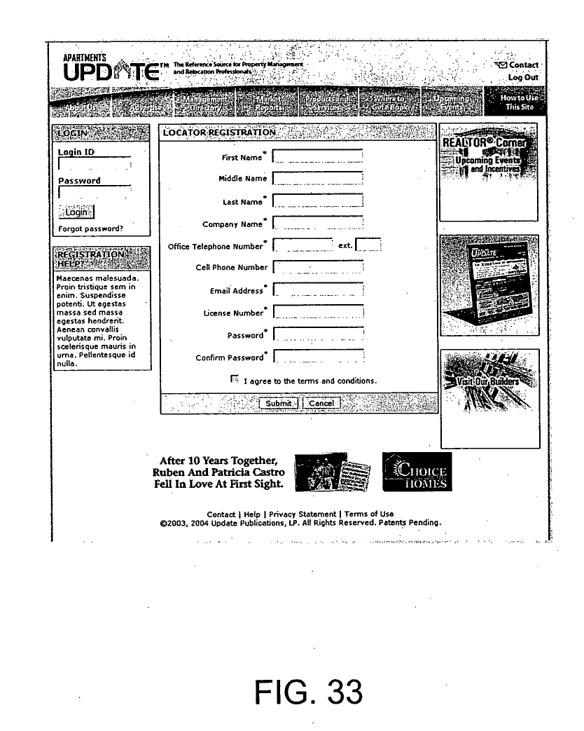

Apartment locators register themselves for access to the site. (FIG. 32, middle left, FIG. 33, center) They are required to provide a valid state real estate license number to verify that they are qualified locators. All other users must be registered by existing, authorized users. Update Administrators can add users of any type. Property management company supervisors and area supervisors can add users who report under them in their company's management hierarchy.

Property management companies and others may expose their paid promotional material by purchasing display space on most pages of the site, including the center of the Welcome page, right navigation area, and bottom banner ad. (See FIG. 32 as an example.) Included with the promotional material are self-promotional items such as the Did You Know, FIG. 32, bottom right.

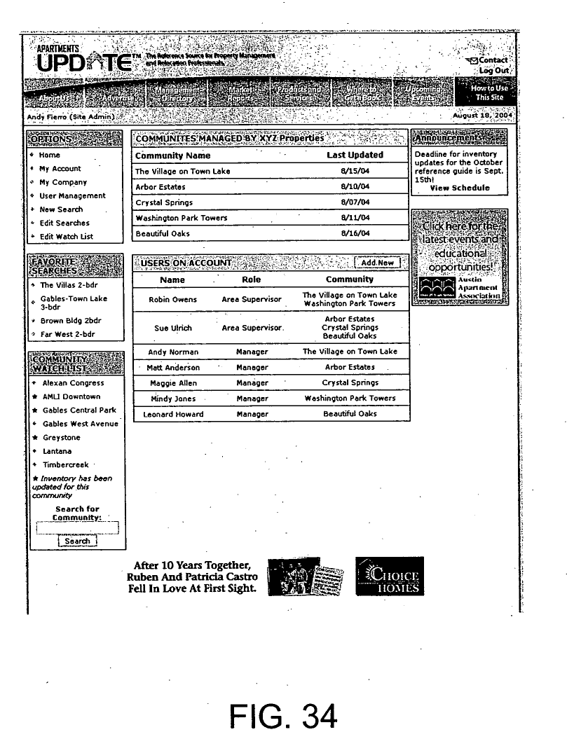

Once a user is logged in, the left side navigation area is the same on every page that user visits. (FIG. 34, for example). The Options block (upper left) contains links to standard areas of the site and is common to all non-locator users. Navigation is personalized; for example, locators do not have links for My Company or User Management. The Favorite Searches block (middle left) executes user-predefined apartment searches. Each user can add, modify, or remove entries from this block. The Community Watch List (lower left) contains links to apartment communities selected by the user. The Search for Community field at the bottom of this block allows a user to locate an apartment community by name.

Built-in communications from the publisher includes the contents of the Announcements block (FIG. 34, upper right for example), which appears on most pages. It contains resetable information from the publisher, with optional links to more detailed information.

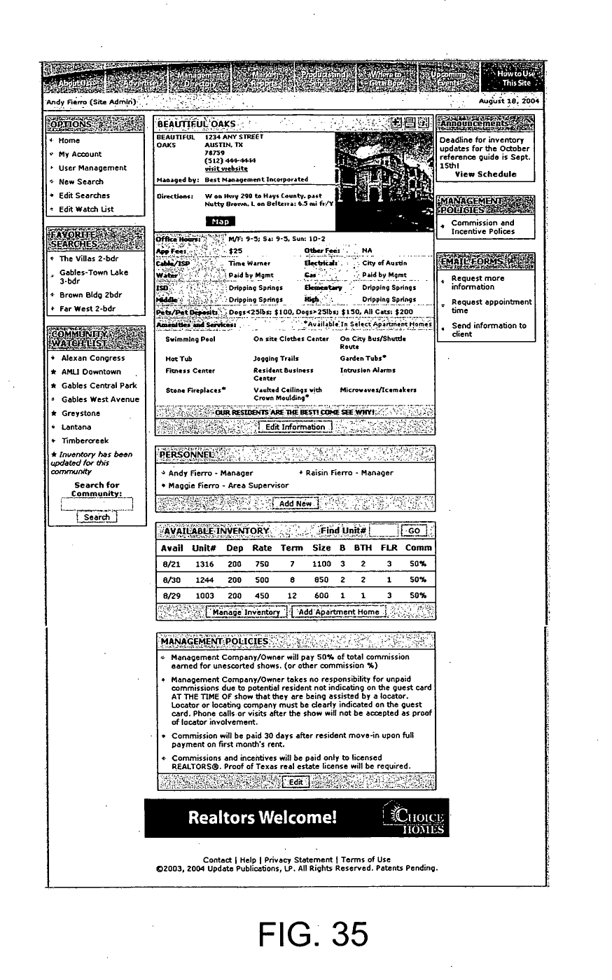

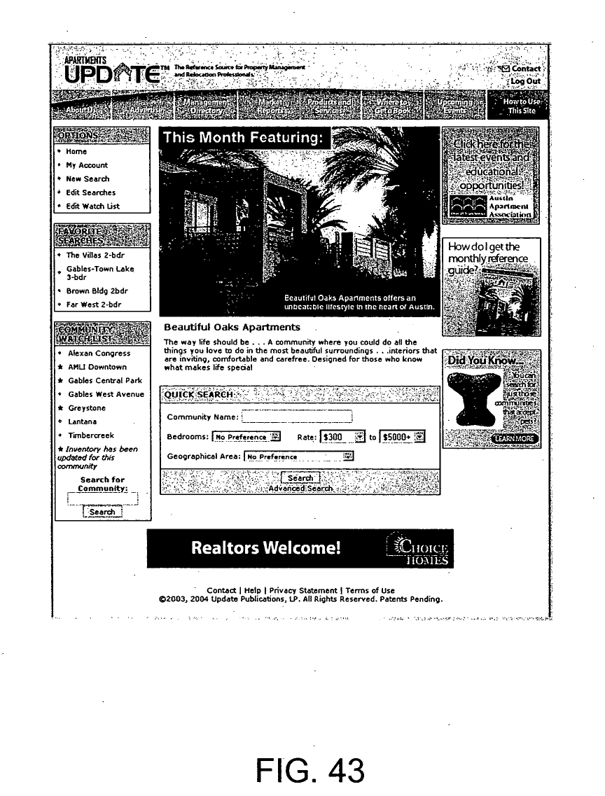

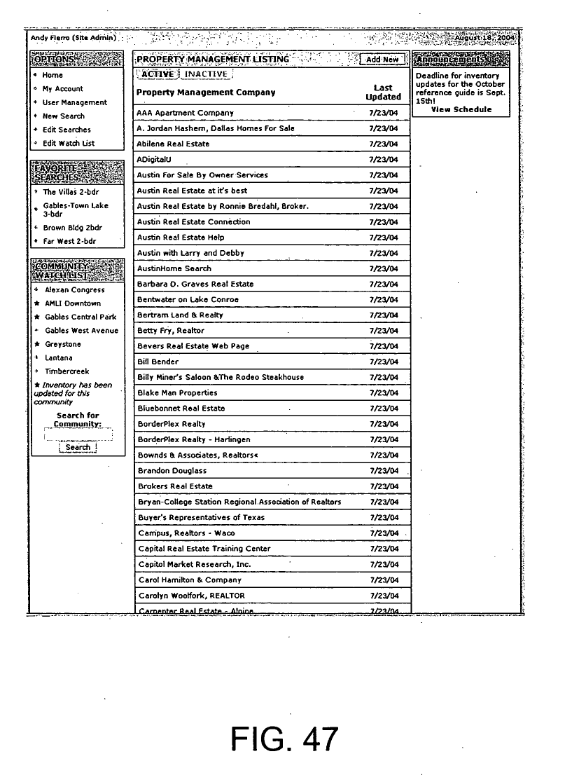

Home pages are personalized in that each logged in user sees a home page that is specific to his or her job function. The home pages provides are property management company supervisor or area supervisor (FIG. 34), community manager (FIG. 35), locator (FIG. 43), and site admin (FIG. 47).

Supervisor/Area Supervisor home pages display a list of properties the individual manager is responsible for. Clicking on a Community Name opens the home page for that community. (FIG. 35) The Last Updated date indicates when information for the community was last updated. This allows the manager to quickly see that information for each property is being kept current.

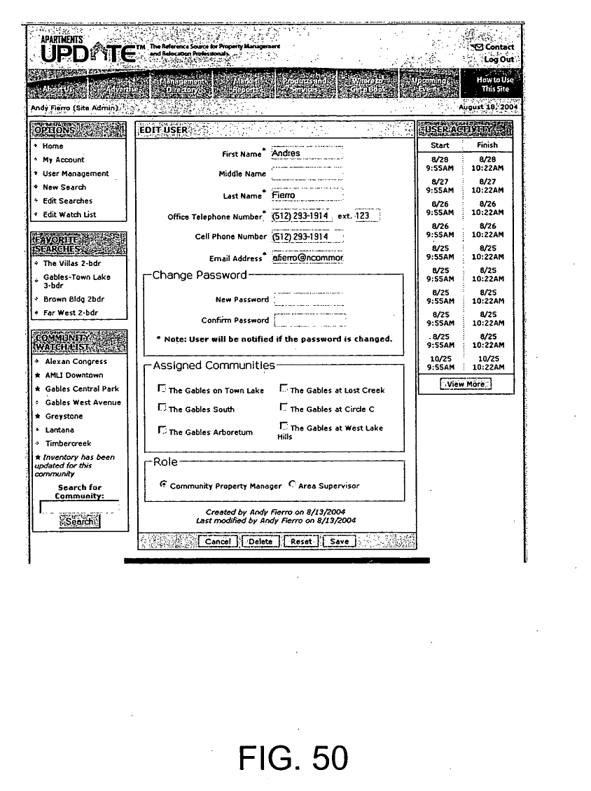

Supervisor/Area Supervisor home pages also display a list of all registered users that work for the management company. Clicking on a Name opens a form displaying the current information for that user and allowing that information to be edited. (FIG. 50) Clicking on a property name opens the internal home page for that property. (FIG. 35) When an individual is responsible for more than one property, all are displayed. Because management has a hierarchical structure and we allow crossover, any given property may be the responsibility of two or more individuals.

Supervisor/Area Supervisor home pages further allow a supervisor or manager to use the standard Community Watch List block (lower left) to list key competitors. This makes it quick and simple to regularly check on what's happening at the competitors' communities.

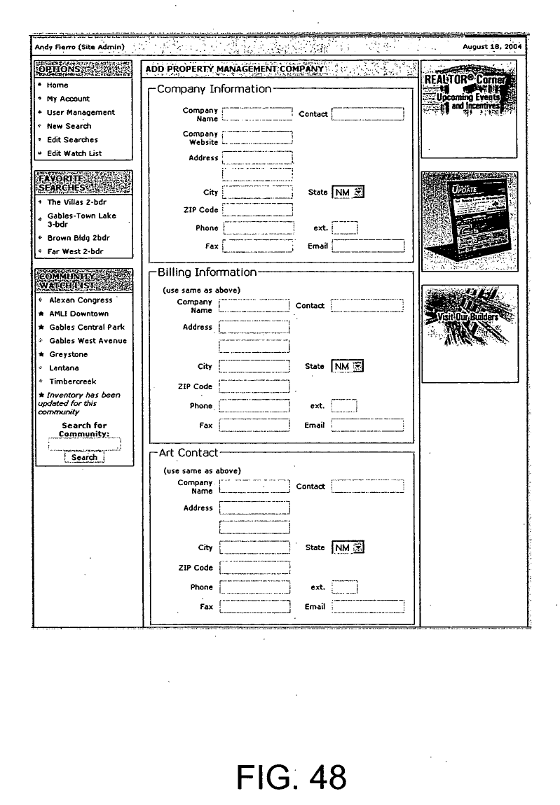

The top section of the Community Manager home page displays all of the community's descriptive information that is currently stored in the database, in the same format in which it is seen by locators. Clicking the Edit Information button at the bottom of this section allows the manager to change any of the descriptive information. (FIG. 48) This button and other update buttons on this page are shown only to managers of this management company and to update site administrators. Locators and managers from other companies do not see these buttons.

The Personnel section of the Community Manager home page lists all of the registered users with responsibility for the property. Clicking a name in the list opens the information form for that individual. (FIG. 50) This feature is provided only to supervisors and area supervisors. Clicking the Add New button allows a new user to be created. (FIG. 50) This button is presented only to supervisors or area supervisors. Property managers cannot add users to the site.

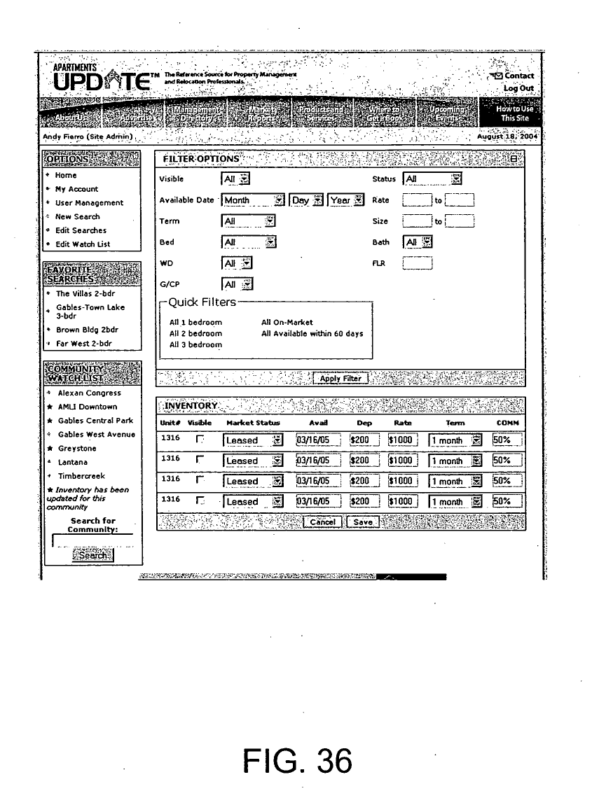

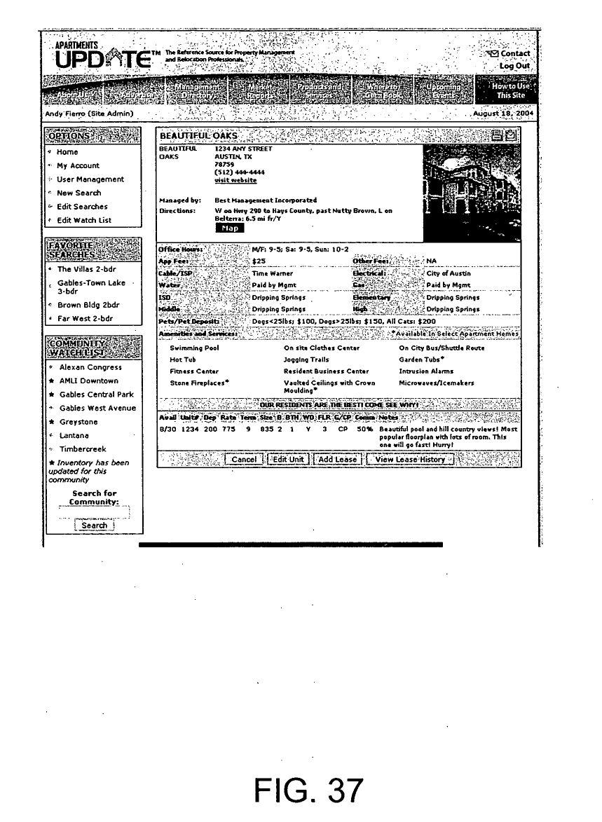

The Available Inventory section of the Community Manager home page lists all available apartments on this property. When this list is presented to a locator or someone from another management company, only those apartments made visible my property management are displayed. This allows management to conceal the exact number and nature or available apartments. Clicking on a Unit# opens page displaying detailed information about the apartment. (FIG. 37) From the details page, the manager can choose to edit information about the selected unit. A user can see details for any apartment by entering the unit number in the Find Unit# field at the top and clicking the Go button. Clicking on the Manage Inventory button opens the batch update page (FIG. 36) where a manager can quickly make changes to the leased/available/on market status of a group of apartments. Clicking on the Add Apartment Home button opens a form where a new apartment home can be added to the community.

The Management Policies section of the Community Manager home page displays the policies and guidelines for paying commissions that area currently shown to locators. Clicking the Edit button allows the user to change the displayed policies.

The top section of the Locator home page displays promotional material about the currently featured apartment community. In a different embodiment, this section is targeted at the geographical area and observed class of apartments favored by each individual locator.

The Quick Search section of the Locator home page allows a locator to search for available apartments using just the most commonly used attributes. For a more specific search, the locator can use Advanced Search by clicking on that link at the bottom.

Moreover, a locator can use the Community Watch List (lower left) to list communities that he or she frequently works with. Clicking a community name will display that community's home page where the locator can immediately see a summary of available apartments at the community. Each community in this list is marked with a star when its inventory has changed since the last time this individual locator visited the home page for the community. Also, because the left navigation is displayed on every page this user visits, she can quickly go through this list.

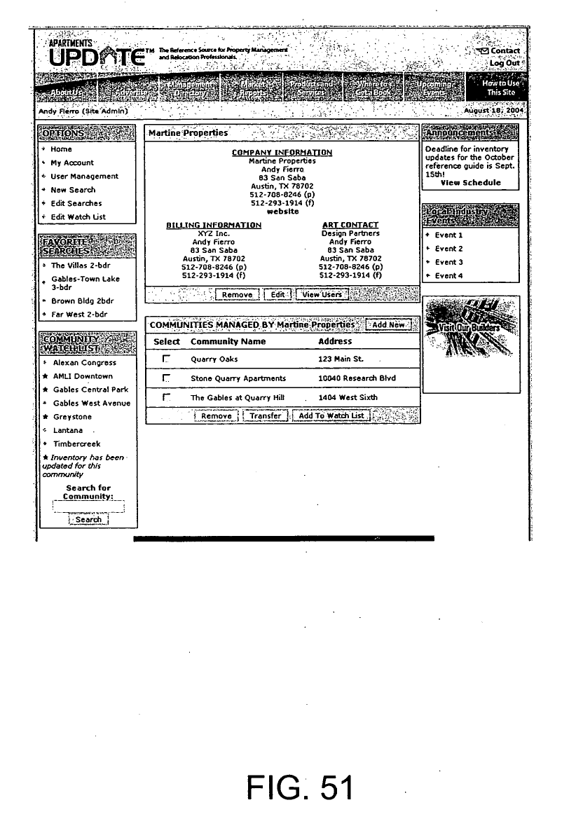

The center section of the Update Site Admin home page displays contains a list of all of the active property management companies on the site. Clicking on the name of a management company opens the summary page for that company. (FIG. 51). Clicking on the Inactive tab switches to a list of all inactive property management companies. Clicking on the Add New button opens a form where a new property management company can be added to the site. (FIG. 48)

The site allows property management staff to manage apartment inventory by managing information about apartment homes and the leased status of apartment homes in each community. In managing apartment information, managers can address each apartment unit individually, or they can make changes to a group of selected apartments on a single form.

Using “Select a Single Apartment for Update,” apartment information for an apartment in a particular apartment community can be updated only by management in the property management company that operates that community or by an Update site admin. Anywhere that a list of apartment units appears, click on the Unit# for an apartment to select that apartment. On an Apartment Community home page, in the Available Inventory section, enter an apartment number in the Find Unit# box and click on the Go button.

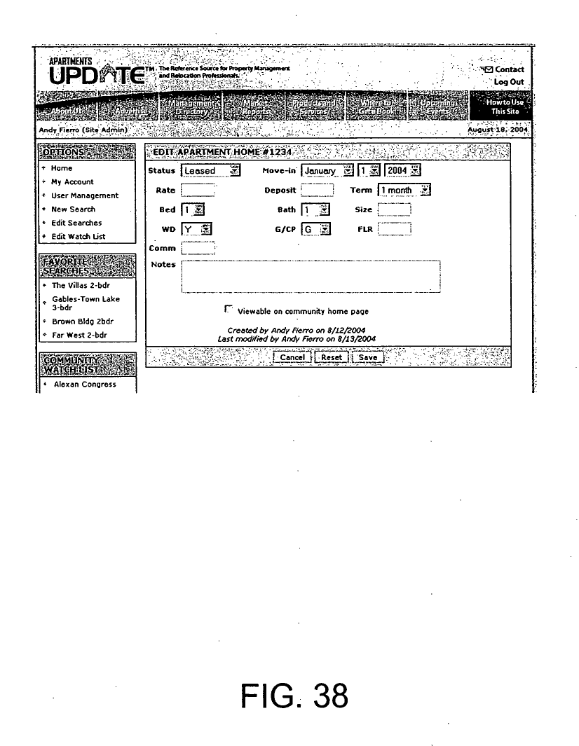

When a single apartment is selected for update, a page summarizing the current apartment information is displayed as an Update Apartment Physical Description. (FIG. 37). To edit the physical description of the apartment, click on the Edit Unit button. The Edit Apartment Home form is displayed. (FIG. 38) If this button is not displayed on this page, the current user is not permitted to edit this information.

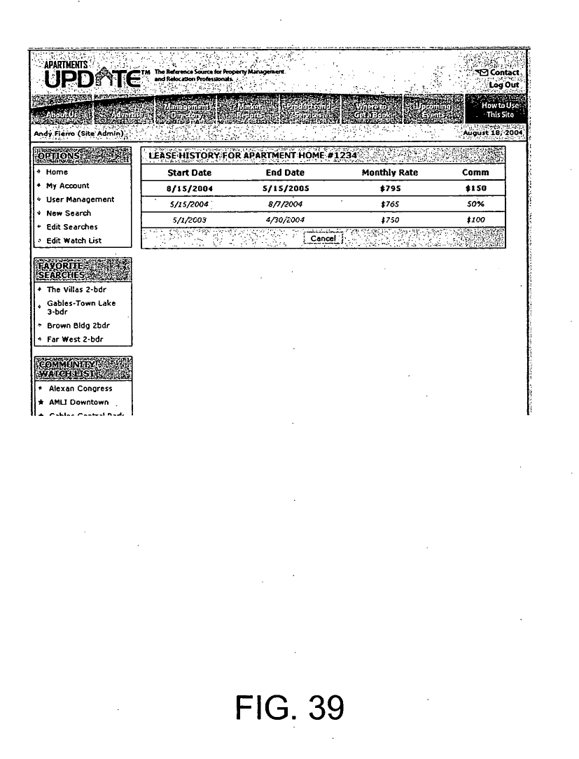

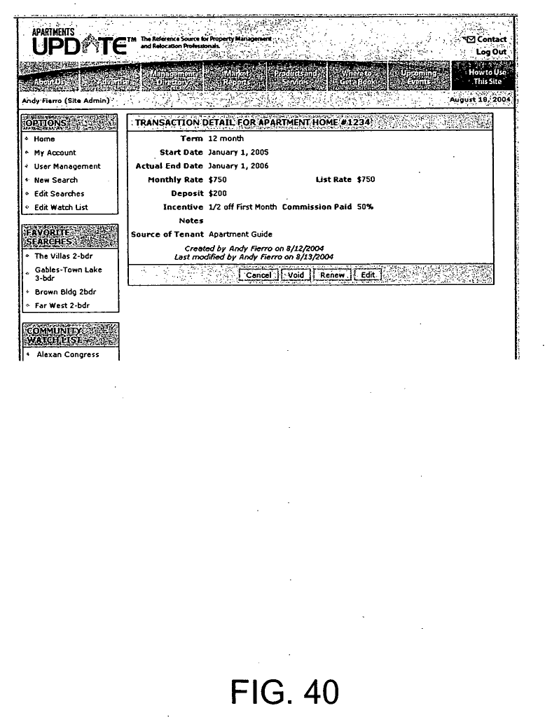

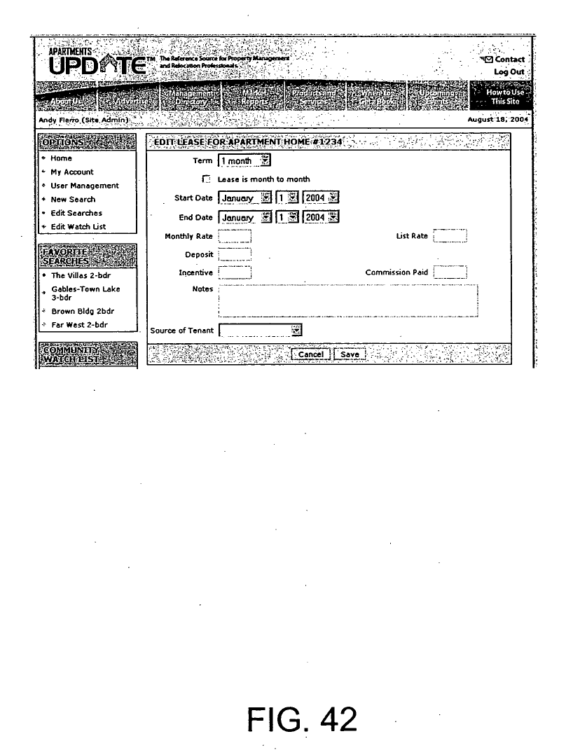

From the Apartment Unit Summary page (FIG. 37), click on the View Transaction History button to update information for an existing lease on a single apartment. This will display the Lease History for Apartment report (FIG. 39). Transactions listed in italic font are closed and cannot be edited. Transactions listed in color may be edited. Clicking on the Start Date displays the Transaction Detail for Apartment page (FIG. 40). Using the buttons at the bottom of this page, the user can void the lease. This action removes the record of the lease from the database. This action should be used only for leases that were created in error. Alternately, the user can renew the lease. This action opens the Renew Lease for Apartment form (FIG. 40). Alternately, the user can edit the lease. This action opens the Edit Lease for Apartment form (FIG. 42).

The Transaction Detail for Apartment page (FIG. 40) shows the tracking of marketing sources. For instance, “apartment guide” is denoted where an apartment has been leased to an individual who learned of the apartment's availability in an apartment guide. Such tracking can be closed, open, or mixed. Closed tracking denotes use of a drop-down list offering a limited list of predefined marketing sources, such as “apartment guide,” “apartment locator,” and “passing by.” Open tracking denotes collection of freeform information, which allows greater freedom of input. The advantage of open tracking is that new marketing sources can be recognized, such as, “recommended by a radio personality.” The disadvantage of open tracking is that data handling is impaired by the same sources being identified in multiple ways, such as “apartment guide,” “apartments guide,” “apartment booklet,” and even misspellings, such as “apartment guidde.” Mixed tracking would include some combination for restricted and unrestricted input. Marketing sources for residential property sales would likely differ from those for residential property leases. For instance, a home builder's website would be a likely source for sales, but not for leases. Likewise, while an apartment guide would be a likely source for leases, it would be an unlikely source for sales.

From the Apartment Unit Summary page (FIG. 37), click on the Add Lease button to create a new lease for a single apartment. This displays the Add Lease for Apartment form which is essentially similar to the Renew Lease form (FIG. 39).

Sales of residential property are typically handled differently than leases. For instance, many embodiments handling sales, but not leases, of residential property are geared toward sales of residential property by home builders rather than by individuals. Accordingly, in such embodiments, it would be most appropriate to consider the history of comparable property sales because the properties on the market are newly constructed residential properties which have no transactional history. In the case where a home builder has participated in developing a subdivision, comparable sales would become readily available once a significant number of subdivision properties had been sold.

From the managers view of a community home page (FIG. 35), in Available Inventory, click on Manage Inventory to select a group of apartments for batch update. This displays the Batch Update page (FIG. 36). In the Filter Options section, select the criteria to use in selecting apartment for updating. Typically this would be either Available Date (selects all apartments which will become available on or before the selected date), or number of bedrooms; but any combination of criteria may be applied. Apartments within this community that meet the criteria are listed in the Inventory list at the bottom.

In the inventory list, click on a Unit # to update any of the information for a single apartment in the batch list. Any of the items listed in this form may be changed within the form, and saved all at once. This simplifies certain common actions. For example, to change the commission plan for all two-bedroom apartments, select all two-bedroom apartments (or just those expected to be available by a given date) and in the resulting list, enter the new commission for this type of unit in the COMM field in each line. When you click Save, all of the changed apartments are updated.

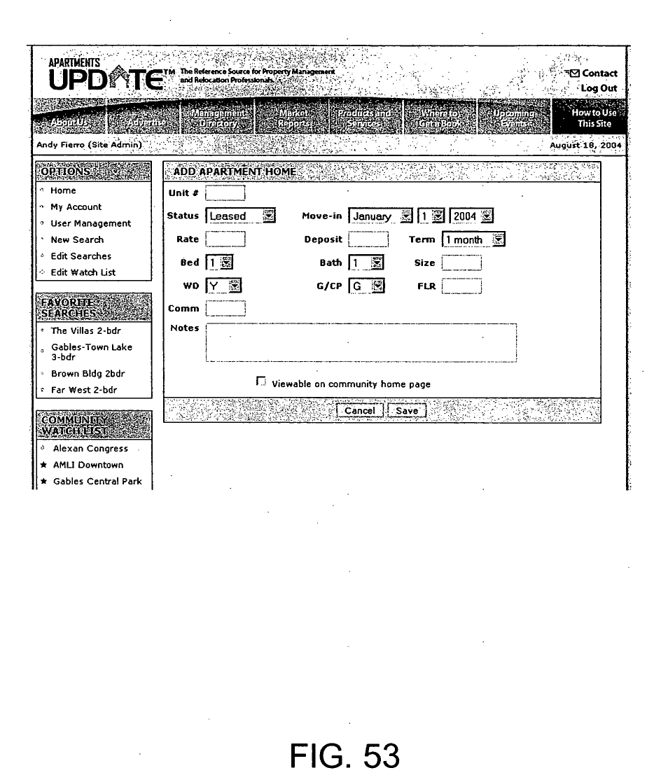

There are a number of reasons why it may be necessary to add apartments to an existing community. On the community home page (FIG. 35), in the Available Inventory section, click on the Add Apartment Home button to get to the Add Apartment Home form. (FIG. 53)

An apartment cannot, technically, be removed from the database because the leasing history for every apartment is considered in the historical data analysis. In the event that an apartment ceases to exist either because it is destroyed or because it is converted to some other purpose, the apartment has its status changed to off-market, and the notes field for this action can explain the cause. Off-market apartments are never considered available.

In addition to updating apartment information online, a management company can choose to perform batch load apartment updates from an uploaded file. File updates can be set up to run daily or weekly, and can either run automatically at a set time and day, or the updates may be set up to run only when enabled by a community manager. Batch files are also used for the initial setup of a new apartment community. Files may be submitted as XML documents or CSV flat files, using standard formats defined by the publisher.

A primary purpose of this web site is to allow apartment locators to quickly and easily locate available apartments by identifying available apartments which match the needs of their individual clients. On the publisher's site, locators have three ways to identify available apartments.

The home page for each apartment community includes a summary list of available apartment inventory at that community. By visiting a community's home page, a locator can see available inventory at a glance, enabling the locator to find available apartments at specific apartment communities. A locator (or any other registered user) can go directly to a community's home page using the Community Watch List. If the target community is listed in the Community Watch List, simply click on that community in the list. If the target community is not listed, enter all or part of the community's name in the Search for Community Field at the bottom of the watch list. A list of all communities whose names contain the entered text will be displayed. Click on any community name in that list to go to the home page of the community.

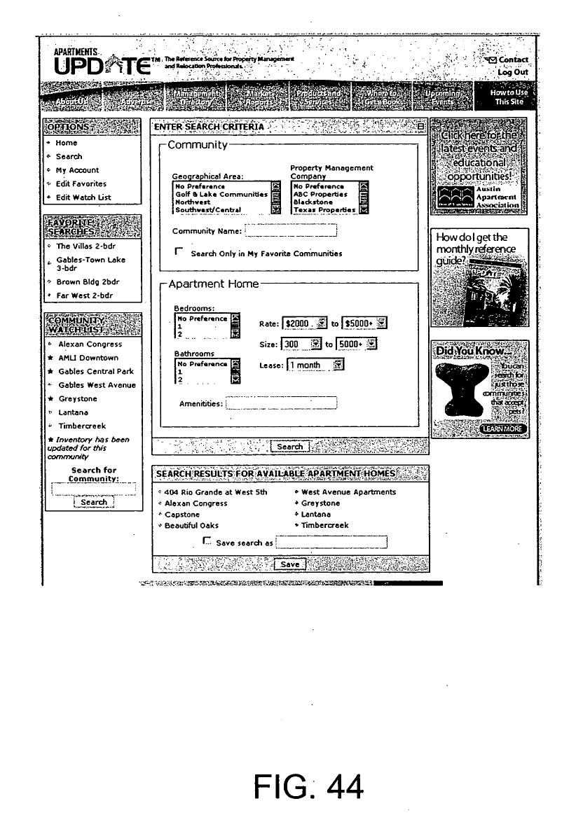

Both Quick Search and Advanced Search are used when the locator wants to get a list of all apartment communities that have available apartments that match specific criteria. Quick Search is used for most ordinary searches. Advanced Search is used when the client has very specific requirements. Quick Search is accessed from the Locator Home page (FIG. 43), in the Quick Search Section. Advanced Search (FIG. 44) is reached by clicking the Advanced Search link at the bottom of the Quick Search section. The output of both search methods is a list of apartment communities with available apartments that match the specified criteria. Clicking on a community name in the list displays that community's home page.

Each individual registered user has her own list of favorite searches—a favorite searches list. Favorite Searches are displayed in the left side navigation area and are always available to a user. Whenever a search is executed, the user has the option of saving that set of search criteria with a name assigned by the user. Clicking Edit Favorites in the Option block displays a list of the user's current favorite searches. The user can change the name or remove individual searches in the list.

Each individual registered user has his own list of communities that he can navigate to directly from the Community Watch List block—a community watch list. The home page for each apartment community has a small “+” icon at the upper right of the center section. Clicking that icon adds the displayed community to the user's watch list. Clicking Edit Watch List in the Options block displays a list of the communities in this user's watch list, and allows the user to delete items from the list.

Managing users includes registering, adding, modifying, and removing users. Only locators can register themselves as new users of the site. To register, a locator clicks the Register button in the Locator Registration block on the Welcome page. (FIG. 32) and completes the locator registration form. (FIG. 33). The required license number is the locator's real estate license number. The license number can be used to verify the authenticity of a locator and to ensure that each locator registers just one time.

New site users can be added by registered, authorized users. Update Site Admins can add any type of user. Property managers can add users that report under them in their company management structure—a supervisor can add area supervisors and community managers, an area supervisor can add community managers. Community managers and locators cannot add users to the site. To add new users for a property management company, on the home page of that property management company, click on the Add New button in the Users on Account section. (FIG. 34) This opens a form for adding new users. Essentially, this is similar to the Edit User form shown in FIG. 50. The user may be assigned to any or all of the communities managed by this management company. Only those communities for the current management company are displayed as options. The role of the user is selected in the Role section. A user can have only one role. Each property management company has only on supervisor, and the supervisor is added only by an Update Site Admin.

Any site user can modify his or her own personal information. In addition, some users can modify the information for certain others users. Update Site Admins can change the information for any user except another Update Site Admin Property management company supervisors and area supervisors can change the personal information for those who report under them in the company's management hierarchy. When a user's password is changed by another, authorized user, the user whose password was changed is notified by email that his password has been changed, but is not told what the new password is. This allows a user to identify possible unauthorized access to his account.

Technically, site users are never removed from the database. Individual users can be disabled which makes them not visible on the site and prevents them from logging in. Users can be disabled by the same class of users that can add them, with one exception: Update Site Admins cannot be modified or removed through the front end UI. As a security precaution, these actions must be done by a technical staff member of the publisher.

The preceding paragraphs discuss various property managers: supervisors, area supervisors, and community managers. These types of property managers are not necessarily appropriately associated with many embodiments dedicated to handling residential property sales, but not residential property leases. For instances, a rented apartment will often be governed by a community manager, an area supervisor, and a supervisor. However, an occupant-owned house will not necessarily be governed by such a management structure. Of course, it is possible for such management structures to govern owner-occupied housing by virtue of homeowner's associations and other mechanisms. Those skilled in the art will understand that such variations fall within the spirit and scope of the present invention.

The site automatically logs the date, time, and user ID when any change is made to an apartment community's inventory. This allows a manager to verify that regular updates are being made and possibly to identify inappropriate actions by a user. The User Activity Log for an individual user is shown on the Edit User form for that user. (FIG. 50). The form shows the 10 most recent activities for the user. Earlier activities can be displayed by clicking the View More button.

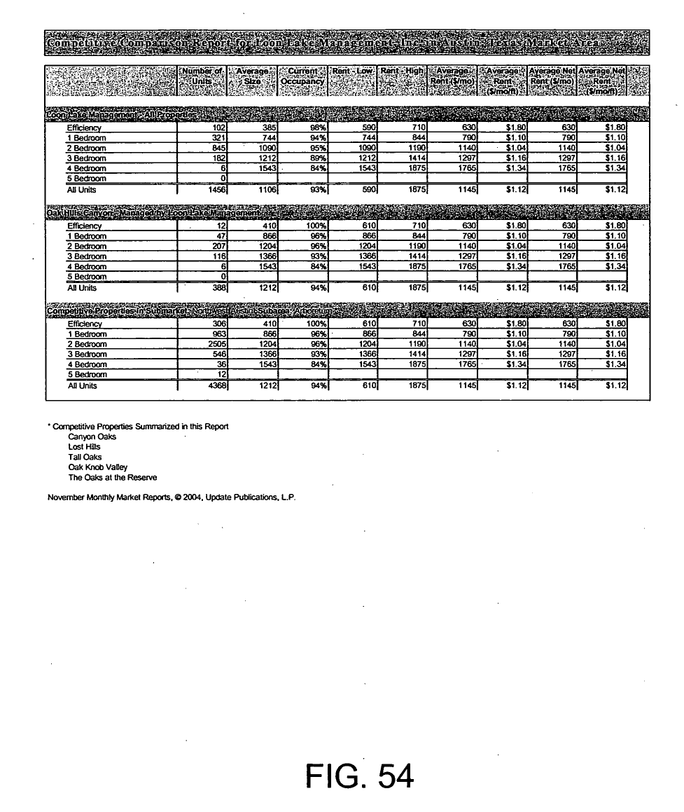

The analytical reports use both current and historical data to provide valuable marketing information to our subscribers. A sample report is shown in FIG. 54. All reports are generated automatically once a month in printable PDF format. In future releases, users may be able to request updated reports at any time, but this capability is not included at this time. Users may specify individual preferences for the content of some reports. If no individual preferences are indicated, default settings are used when reports are generated for that user. In this release, preferences apply to report content only. Customization of report layout is not supported.

A user accesses the Report Preferences page by clicking the Set Preferences link in the Reports block on the bottom of his left side navigation area. The preferences for are specific to the particular report. The report descriptions below indicate what can be configured for each report. Some reports do not have configuration options. Note: When the default settings are used for a report, the content of a particular report will still depend on who that user is and what information he is permitted to see.

When the monthly reports have been generated, each user is sent an email notice that the reports are available. When a user logs into the system, he will also see a notice in the Reports block at the bottom of his left side navigation area indicating that new reports are available. A user accesses his reports by logging into the publisher's site and either going to the View Reports page, on which the user sees a list of the reports that are available to him (clicking on a report name, downloads that PDF report into his browser, and from there it can be printed or saved locally) or clicking on one of the named reports in the Reports block at the bottom of his left nav, which also downloads the report into his browser.

The Competitive Comparison Report (CCR) allows a management company to compare the performance of one or more of its properties against the aggregated performance of a selected set of its competitor properties. In CCR content selection a user can specify both the set of managed properties and the set of competitive properties to be represented in this report.

A management company may select for inclusion in the report just one of its properties, multiple specific properties, all of its properties within a designated submarket area, or all of its properties within this local market. When more than one property is selected, each selected property is listed individually and aggregated data for all selected properties is also provided.

Competitor data is provided only in aggregate to prevent the exposure of confidential information related to competitor properties. The management company may select specific competitive communities (minimum of three) or competitive communities based on submarket, class, or other criteria. If the selection criteria do not yield at least three communities to be aggregated, the report will not be produced. The default settings for this report are (a) for on-site managers—the property they manage and all competitive properties within their submarket, (b) for supervisors and area supervisors—all of the properties for which they are responsible and all competitive properties in the local market.

The Competitive Comparison Report consists of five sections. Report Contents lists the managed property or properties and the competitive properties included in the report. Physical Comparison compares the managed and competitive properties based on physical characteristics such as number of units in each floor plan, size of units, age, and geographical location. Rental Comparison compares overall current status of managed and competitive properties in such categories as occupancy, average rental rate, rental adjustments, and net rental rate. Rental Comparison by Key Feature compares overall current rental status of managed and competitive properties broken out by floor plan and by size of unit. Finally, Historical Analysis provides graphical comparisons of the managed and competitive properties in Occupancy, Market Rent, Net Rent, and Time to Market. The period covered will be the previous 12 months.

The Management Company Portfolio Analysis (MCP) compares all of the properties managed by a property management company to aggregated data for all properties within the local market (e.g., Austin area). When the publisher serves more than one local market, this definition may be changed. In this version, a user has no input into selecting the content of the report. This report includes all of the properties managed by the company within the local market, and is broken out by submarket area.

The Management Company Portfolio Analysis consists of six sections. MCP Report Contents lists the properties addressed in the report, organized by submarket. MCP Physical Comparison Summary compares aggregated physical data for managed properties against all properties within the market and within each submarket. MCP Physical Comparison Detail compares physical data for each managed property against aggregated data for all properties within the market and within each submarket. MCP Rental Comparison Summary compares aggregated rental data for managed property against all properties within the market and within each submarket. MCP Rental Comparison Detail compares rental data for each managed property against aggregated data for all properties within the market and within each submarket. MCP Historical Analysis graphical comparisons of the managed properties with aggregated data for all properties within the market and within each submarket for Occupancy, Market Rent, Net Rent, and Time to Market for the last 12 months.

The Local Market Analysis (LMA) provides aggregated data for all of the properties within the local market (Austin) area. Data is aggregated and compared for the entire market and for each submarket within the market and all classes and broken out by the individual classes of the properties. The Local Market Analysis is a standard report which is the same for all subscribers. In the current version there is no customization.

The Local Market Analysis consists of three sections. LMA Aggregated Market Performance lists aggregated market size and performance information for all properties in the entire market, and for each submarket. LMA Market Performance by Class lists market size and performance information broken out by property class. Separate sections are included for the overall market and for each submarket. LMA Historical Analysis provides graphical representation of trends in overall market size and mix of apartments based on floor plan and size.

The Property Marketing Report (PMR) provides critical marketing performance data for a property management company. Data is provided for each property managed by the company and aggregated for all properties. A property management company can also see its marketing performance compared to aggregated, normalized numbers for other properties in each submarket in which it operates.

A user may select a minimum of three competitive properties in any or all submarkets for comparison with his company's own managed properties. If no competitive properties are selected, comparisons are made to aggregated data for all competitive properties in each submarket.

The Property Management Report consists of three sections. PMR Leased Units by Marketing Source breaks out the total leased units per company and per property broken out by marketing source. Competitive comparisons are aggregated totals. PMR Leased Units by Incentive breaks out the total leased units per company and per managed property broken out by locator incentive. PMR Leased Units by Concession breaks out the total leased unit per company and per managed property broken out by lease concessions.

The Quarterly Local Market Trends (LMT) is a statistical and narrative analysis of key business indicators within the local market viewed over the most recent calendar quarter. The Local Market Trends report is a standard report which is the same for all subscribers. In the current version there is no customization. The Local Market Trends report looks at long term trends in occupancy, unit absorption, floor plan mix, and property class mix, broken out by submarkets, and focus areas within the sub-areas.

APPENDIX 1 contains an 11-page web site and database design and development description related to the present disclosure. APPENDIX 2 contains a 13-page online FAQ for builders related to the present disclosure. APPENDIX 3 contains a 30-page online builder inventory and reports system tutorial related to the present disclosure. APPENDIX 4 contains a 30-page January Market Report 2004 related to the present invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing embodiments of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The term “Primary Data” as used herein means collected data. The term “Secondary Data” means data created based on Primary Data.

Primary data can be collected in the form of individual transactions or in the form of aggregate data representing multiple transactions. In either case, the primary data can then be combined to create highly aggregated data. In addition, the same primary data can be collected more than once, possibly in different forms. For example, home sales in a neighborhood can be collected from the neighborhood builder in the form of individual transactions and also be collected from realtors in the form of aggregate data including transactions occurring within the neighborhood over a period of time. The data collected from each source can then be compared to identify differences, if any. If differences are present, steps could be taken to resolve the inconsistency. Such comparison and resolution could facilitate improved data integrity and could encourage submission of more accurate data.

It is helpful for many participants in the real estate industry to have an overall understanding of the real estate market. In order to achieve and maintain an overall understanding, real estate professionals and others who need an overall understanding of the real estate market, such as developers, appraisers, lenders, potential large employers planning workforce moves, journalists, etc., have been forced to access multiple sources to separately achieve and maintain an understanding of apartment data and home data. One teaching of this disclosure is a solution including normalization which allows apartment data and home data to be compared on an equivalent basis. Accordingly, the term “apples-to-apples” as used herein means facilitating comparison on an equivalent basis.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

For example, historical sales information could be collected by the disclosed systems in order to allow trending analysis over a lengthier period of time. In addition, builders could upload and manage their own inventory of homes for sale, including submitting their historical sales.

Another variation in some systems and methods of the disclosed invention generates statistical reports including information on sales, average price, subdivision activity, and builder rankings.

A third modification allows the collection of information followed by distribution of that information to a consumer magazine publisher or other commercial consumer of information in order to facilitate improvement of the consumer magazine's product.

Yet another variation involves implementation of various messaging models. For example, messaging can be used as described above to encourage information sources to submit data. Messaging can also be used to inquire of builders which homes are to be promoted. Security can be enhanced by sending a message a master account upon request by a sub-account related to the master account for a password reminder or upon updating of information falling within the prevue of the master account. Messaging can contain be used to distribute a monthly report in electronic format. Additionally, realtors can be alerted by messaging when a particular home is sold or upon some other trigger event.

Furthermore, all information can be stored in XML or any other format without departing from the spirit and scope of the disclosed invention. The portal website can also maintain one or more calendars with date-related information.

Still another variation is to track information pertaining to apartment locators in order to reduce the potential for fraud. Conventionally, apartment locators physically accompany an apartment seeker to an apartment complex to view a potential unit. While physically at the apartment site, the locator signs in. If the apartment seeker rents the viewed unit, there is then a record indicating that the locator should be paid a commission. However, some apartment locators merely send apartment availability information to apartment seekers and call the apartment site later in an attempt to collect a commission if the apartment seeker has rented the available unit. Apartment sites often pay such locators despite the fact that the locator has not physically signed in. As a result, some dishonest locators call apartment sites seeking commissions on rented apartment units without having send the apartment seeker to view the unit.

The disclosed collection methods and systems can be utilized to gather information pertaining to locators in order to identify locators who repeatedly call requesting commissions without having physically signed in. In addition, the apartment site employee who authorizes such commissions can be tracked do determine whether an employee repeatedly authorizes such commissions. Trending analysis could be utilized to provide yet another view into the resulting data.

Several of the terms used within this application are trademarks or service marks of Update Publications, LP. Such marks are often, but not always, capitalized.

What is claimed is:

1. A method for collecting, processing, and distributing residential data, the method comprising:
establishing at least one client account;
transmitting a message to the at least one client account requesting the client account to provide primary residential data;
receiving primary residential data from the at least one client account, wherein the primary residential data includes:
primary apartment data relating to at least one apartment rental event;
primary home data relating to at least one home sale event;
normalizing the primary residential data on a real-time basis to cause the primary apartment data and the primary home data of the resulting normalized primary residential data to be comparable on an equivalent basis;
generating normalized secondary residential data based on the normalized primary residential data on a real-time basis; and
enabling the normalized secondary residential data and the normalized primary residential data to be accessed via a full-time public network on a real-time basis.

2. A computer-readable signal capable of being propagated across a full-time public network, the signal carrying computer-readable instructions executable for enabling the performing of a method for collecting data to facilitate real time access and efficient reporting comprising the steps of:
authorizing by a master account, via the full-time public network, a sub-account to submit primary data associated with a set of residential property;
transmitting a reminder message to the sub-account requesting that the sub-account submit the primary data;
receiving the primary data from the sub-account via the full-time public network;
receiving a known inquiry from a remote computer user via the full-time public network; and
transmitting real-time secondary data at least partially based on the primary data to the remote user via the full-time public network.

3. A method in a computer system having storage, for facilitating normalized merging of data relating to rental and sales of apartments and homes, the method comprising the steps of:
receiving collective data which includes:
apartment data comprising at least one record relating to rental and sales of apartments;
home data comprising at least one record relating to rental and sales of homes;
providing a standard unit of measurement:
wherein the standard unit of measurement is suitable for at least partially describing the apartment data;
wherein the standard unit of measurement is suitable for at least partially describing the home data;
normalizing the collective data based on at least one component of the collective data;
whereby the records of the apartment data can be compared to the records of the home data on an equivalent basis.
